(19) United States
(12) Patent Application Publication
(10) Pub. No.: US 2024/0137195 A1
(43) Pub. Date: Apr. 25, 2024

(54) CONFIGURED GRANTS AND SEMI-PERSISTENT SCHEDULING FALLING IN A PARTIALLY FULL DUPLEX SLOT

(71) Applicant: QUALCOMM Incorporated, San Diego, CA (US)

(72) Inventors: Ahmed Attia ABOTABL, San Diego, CA (US); Marwen ZORGUI, San Diego, CA (US); Muhammad Sayed Khairy ABDELGHAFFAR, San Jose, CA (US); Abdelrahman Mohamed Ahmed Mohamed IBRAHIM, San Diego, CA (US)

(21) Appl. No.: 18/049,261

(22) Filed: Oct. 23, 2022

(51) Int. Cl. H04L 5/14; H04W 72/0446; H04W 72/11

(52) U.S. Cl. CPC H04L 5/1469; H04W 72/0446; H04W 72/11

(57) ABSTRACT

Aspects are provided which allow for a UE or a base station to handle CG or SPS occasions that fall in a partially full-duplex slot. Initially, the UE receives an indication of a configured grant (CG) or a semi-persistent scheduling (SPS) configuration for allocating CG or SPS occasions. Next, the UE determines whether the CG or SPS occasion overlaps in at least one SBFD symbol in a partially full-duplex slot based on the CG or SPS configuration. Afterwards, the UE communicates with a base station according to a modification to the CG or SPS occasion based on the CG or SPS occasion overlapping in at least one SBFD symbol in the partially full-duplex slot. As a result, the UE and the base station may handle instances where a CG or SPS occasion falls in a partially full-duplex slot without identifying an error conditions or simply dropping the CG or SPS occasion.

### BACKGROUND

### Technical Field

The present disclosure generally relates to communication systems, and more particularly, to modifying semi-persistent scheduling occasions or configured grant occasions.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

A wireless network may include a number of base stations (BSs) that can support communication for a number of user equipment (UEs). A UE may communicate with a BS via the downlink and uplink. “Downlink” (or forward link) refers to the communication link from the UE to the BS, and “uplink” (or reverse link) refers to the communication link from the UE to the BS. As will be described in more detail herein, a BS may be referred to as a Node B, a gNB, an access point (AP), a radio band, a transmit receive point (TRP), a New Radio (NR) BS, a 5G Node B, or the like.

These multiple access technologies have been adopted in various telecommunication standards to provide a common protocol that enables different wireless devices to communicate on a municipal, national, regional, and even global level. An example telecommunication standard is 5G NR. 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A full-duplex UE may receive DL and transmit UL at the same time and frequency band in either an in-band full duplex (IBFD) (e.g., operations in which the DL resources and the UL resources overlap in time and at least partially overlap in frequency) or a sub-band full duplex (SBFD) (e.g., operations in which the UL and DL resources are non-overlapping) manner. Currently, configured grants (CG) and semi-persistent scheduling (SPS) are configurations in the UL-Bandwidth Part (BWP) and DL-BWP, respectively. Some slots can be a mix of half-duplex symbols and full-duplex symbols. For instance, due to a slot having mixed half-duplex symbols and SBFD symbols, a CG occasion may overlap with downlink or guard resources of a slot, such as a SBFD slot. In another instance, due to the slot having mixed half-duplex symbols and SBFD symbols, a SPS occasion may overlap with uplink or guard resources of a slot, such as the SBFD slot. In these instances, it is not clear how a CG occasion or a SPS occasion may behave in those mixed slot types.

A solution may be to simply drop the CG occasion or SPS occasion. However, this will lead to dropping a significant number of occasions that are serving URLLC which is not a favorable solution. Accordingly, it would be helpful to develop techniques on handling a SPS or CG occasion that falls in a partially full-duplex slot.

Accordingly, aspects of the present disclosure allow for a modification of CG or SPS occasions that fall in partially full-duplex slots. For example, the UE may receive an indication of a CG or a SPS configuration for allocating CG or SPS occasions. Next, the UE may determine whether the CG or SPS occasion overlaps in at least one SBFD symbol in a partially full-duplex slot based on the CG or SPS configuration. The UE may communicate with a base station according to a modification to the CG or SPS occasion based on the CG or SPS occasion overlapping in at least one SBFD symbol in the partially full-duplex slot. In this way, the UE and the base station may handle instances where a CG or SPS occasion falls in a partially full-duplex slot without identifying an error conditions or simply dropping the CG or SPS occasion.

In an aspect, the subject matter described in this disclosure can be implemented in an apparatus for wireless communication at a UE. The apparatus includes a memory and at least one processor coupled to the memory. The processor is configured to receive an indication of a configured grant (CG) or a semi-persistent scheduling (SPS) configuration for allocating CG or SPS occasions. The processor is also configured to determine whether the CG or SPS occasion overlaps in at least one SBFD symbol in a partially full-duplex slot based on the CG or SPS configuration. The processor is further configured to communicate with a base station according to a modification to the CG or SPS occasion based on the CG or SPS occasion overlapping in at least one SBFD symbol in the partially full-duplex slot.

In another aspect, the subject matter described in this disclosure can be implemented in an apparatus for wireless communication at a base station. The apparatus includes a memory and at least one processor coupled to the memory. The processor is configured to transmit an indication of a configured grant (CG) or a semi-persistent scheduling (SPS) configuration for allocating CG or SPS occasions.

The processor is also configured to determine whether the CG or SPS occasion overlaps in at least one SBFD symbol in a partially full-duplex slot based on the CG or SPS configuration. The processor is further configured to communicate with a user equipment (UE) according to a modification to the CG or SPS occasion based on the CG or SPS occasion overlapping in at least one SBFD symbol in the partially full-duplex slot.

In another aspect, the subject matter described in this disclosure can be implemented in a method of wireless communication at a UE. The method includes receiving an indication of a configured grant (CG) or a semi-persistent scheduling (SPS) configuration for allocating CG or SPS occasions. The method also includes determining whether the CG or SPS occasion overlaps in at least one SBFD symbol in a partially full-duplex slot based on the CG or SPS configuration. The method further includes communicating with a base station according to a modification to the CG or SPS occasion based on the CG or SPS occasion overlapping in at least one SBFD symbol in the partially full-duplex slot.

In another aspect, the subject matter described in this disclosure can be implemented in a method of wireless communication at a base station. The method includes transmitting an indication of a configured grant (CG) or a semi-persistent scheduling (SPS) configuration for allocating CG or SPS occasions. The method also includes determining whether the CG or SPS occasion overlaps in at least one SBFD symbol in a partially full-duplex slot based on the CG or SPS configuration. The method further includes communicating with a user equipment (UE) according to a modification to the CG or SPS occasion based on the CG or SPS occasion overlapping in at least one SBFD symbol in the partially full-duplex slot.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a conceptual diagram of an example Open Radio Access Network architecture.

FIG. 3A is a diagram illustrating an example of a first frame, in accordance with various aspects of the present disclosure.

FIG. 3B is a diagram illustrating an example of DL channels within a subframe, in accordance with various aspects of the present disclosure.

FIG. 3C is a diagram illustrating an example of a second frame, in accordance with various aspects of the present disclosure.

FIG. 3D is a diagram illustrating an example of UL channels within a subframe, in accordance with various aspects of the present disclosure.

FIG. 4 is a diagram illustrating an example of a network device such as a base station and UE in an access network.

FIG. 5 is a diagram illustrating an example full-duplex wireless communications mode, in accordance with various aspects of the present disclosure.

FIGS. 6A-C illustrate various configurations of full-duplex modes as may be utilized in accordance with various aspects of the present disclosure.

FIGS. 7A-B illustrates examples of a call flow between a UE and a network device such as a base station for modifying semi-persistent scheduling configurations or configured grants to be applied in downlink or uplink communications.

FIGS. 8A-11B illustrates examples of CG or SPS occasion modifications.

FIG. 12 is a flowchart illustrating an example of a method of wireless communication at a UE.

FIG. 13 is a flowchart illustrating an example of a method of wireless communication at a network entity such as a base station.

FIG. 14 is a diagram illustrating an example of a hardware implementation for an example apparatus.

FIG. 15 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

A wireless communications system may support various communications such as half and full-duplex modes. In some scenarios, a base station may operate in a full-duplex mode and a UE may operate in a half-duplex mode. In other scenarios, both a base station and a UE may operate in full-duplex mode. In yet other scenarios, a UE may operate in a full-duplex mode and a base station may operate in a half-duplex mode. In these cases, various resources may be allowed to avoid interference between communications between the various UEs and base stations. There may be two types of full-duplex modes supported by the wireless communications system. In the IBFD mode, a base station and a UE may transmit and receive using the same or overlapping time and frequency resources. That is, the uplink and the downlink resource may share the same IBFD time/frequency resources, such that there may be a full or partial overlap in the uplink and downlink resources. In a SBFD (also referred to as flexible duplex), the UE and base station may transmit and receive at the same time but using different frequency resources. In an SBFD slot, the downlink resources may be separated from the uplink resource in a frequency domain.

A full-duplex mode allows devices to perform both uplink and downlink communication in the same transmission time interval. A full-duplex mode may be in-band full-duplex, in which devices may transmit and receive on the same or overlapping time and frequency resources, or SBFD (also referred to as flexible duplex), in which devices may transmit and receive at the same (or overlapping) time resources but in different frequency resources. More particularly, in a SBFD mode, the downlink resource may be separated from the uplink resources in a frequency domain.

SPS and CG are scheduling resources for the DL and UL, respectively. Currently, SPS and CG are configurations in the DL bandwidth part (DL-BWP) and UL bandwidth part (UL-BWL), respectively. A BWP is a set of attached Common Resource Blocks. A BWP may include all Common Resource Blocks within the channel bandwidth or a subset of Common Resource Blocks. A UE can be configured with up to 4 DL BWP per carrier and up to 4 UL BWP per carrier. The resources of the slots may be allocated using various uplink and downlink grants. For example, an uplink half-duplex slot or a SBFD slot may have uplink resources that are allocated using CGs. A downlink half-duplex slot or SBFD slot may have downlink resources that are allocated using SPS.

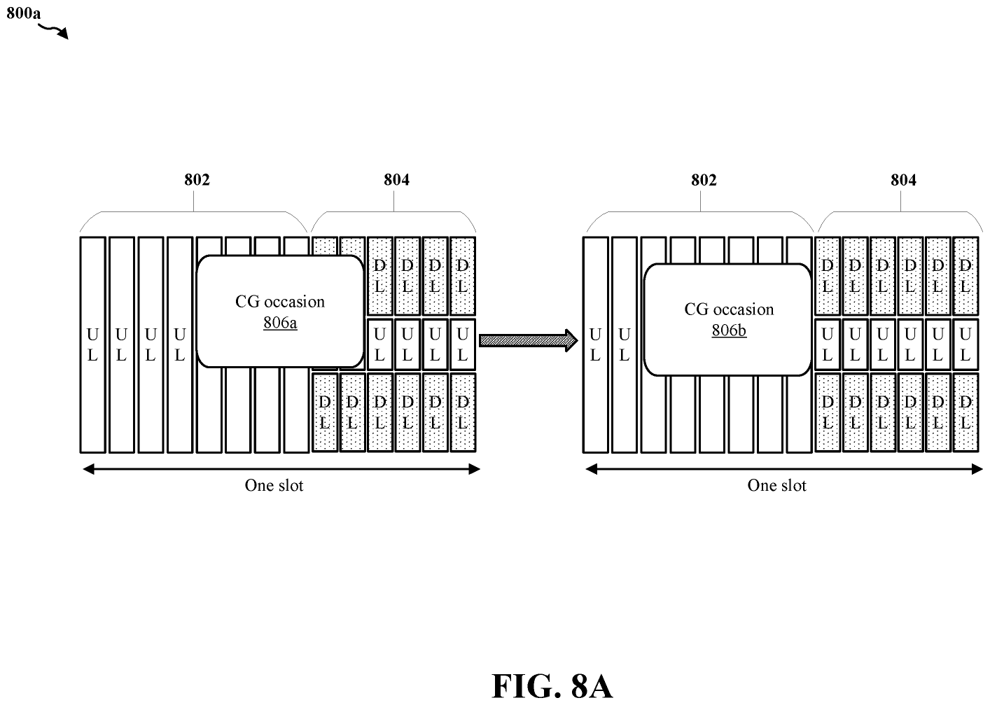

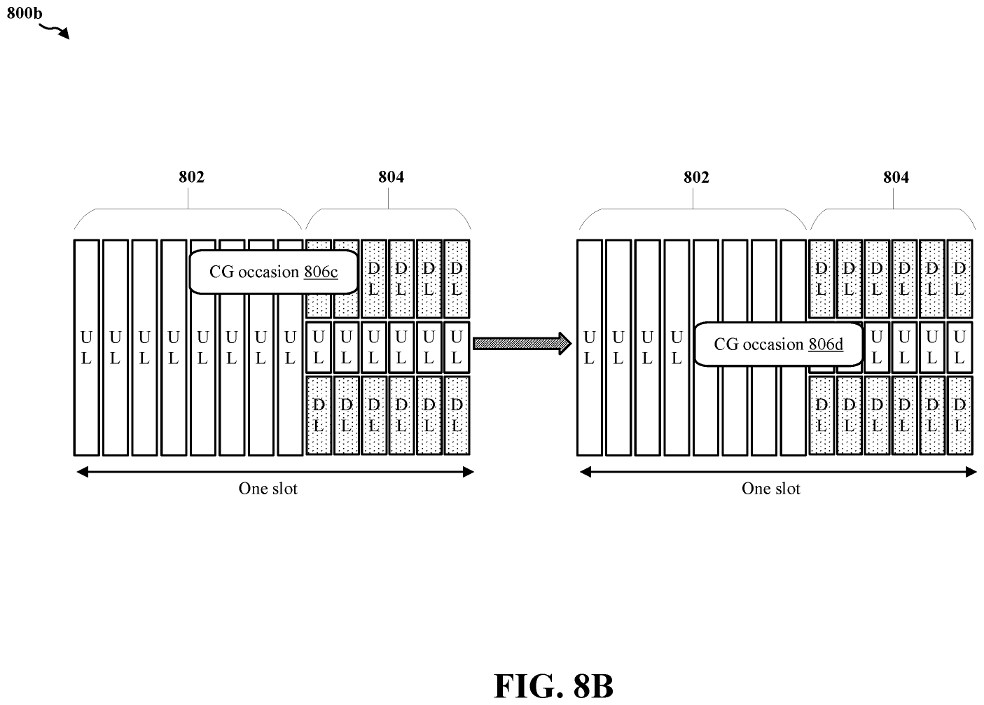

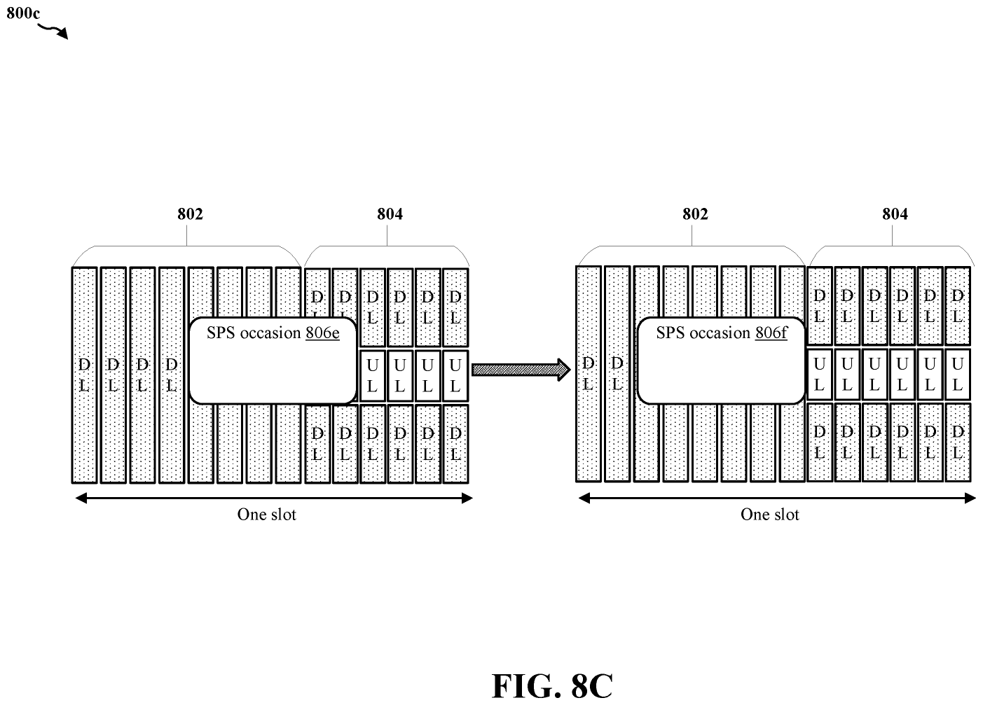

As used herein, a “slot” may refer to a portion of a subframe, which in turn may be a fraction of a radio frame within an LTE, 5G, or wireless communication structure. In some aspects, a slot may include one or more symbols. Additionally, a “symbol” may refer to a OFDM symbol or another similar symbol within a slot. Each slot includes an allocation of resources, which may be referred to as a slot structure. As a non-limiting example and as will be shown below in FIGS. 8A to 11B, a slot may have 14 symbols where the first 8 symbols are entirely UL or DL and the rest of the symbols are SBFD symbols. In addition, a slot may be entirely UP, DL, or SBFD. However, some slots (such as shown below in FIGS. 8A to 11B) may be a mix of half-duplex symbols and full-duplex symbols. In an instance, due to a slot having mixed half-duplex symbols and SBFD symbols, a CG occasion may overlap with downlink or guard resources of a slot, such as a SBFD slot. In another instance, due to the slot having mixed half-duplex symbols and SBFD symbols, a SPS occasion may overlap with uplink or guard resources of a slot, such as the SBFD slot. In these instances, it is not clear how a CG occasion or a SPS occasion may behave in those mixed slot types.

A simple solution may be to drop the CG occasion or SPS occasion entirely. However, this will lead to dropping a significant number of occasions that are serving URLLC which is not a favorable solution. Accordingly, it would be helpful to develop techniques on handling a SPS or CG occasion that falls in a partially full-duplex slot.

In an aspect, the subject matter described in this disclosure can be implemented in an apparatus for wireless communication at a UE. The apparatus includes a memory and at least one processor coupled to the memory. The processor is configured to receive an indication of a configured grant (CG) or a semi-persistent scheduling (SPS) configuration for allocating CG or SPS occasions. The processor is also configured to determine whether the CG or SPS occasion overlaps in at least one SBFD symbol in a partially full-duplex slot based on the CG or SPS configuration. The processor is further configured to communicate with a base station according to a modification to the CG or SPS occasion based on the CG or SPS occasion overlapping in at least one SBFD symbol in the partially full-duplex slot.

Particular aspects of the subject matter described herein may be implemented to realize one or more advantages. The described techniques may support improvements in the SPS and SBFD framework, decreasing signaling overhead, and improving reliability, among other advantages. As such, supported techniques may include improved network operations and, in some examples, may promote network efficiencies, among other benefits.

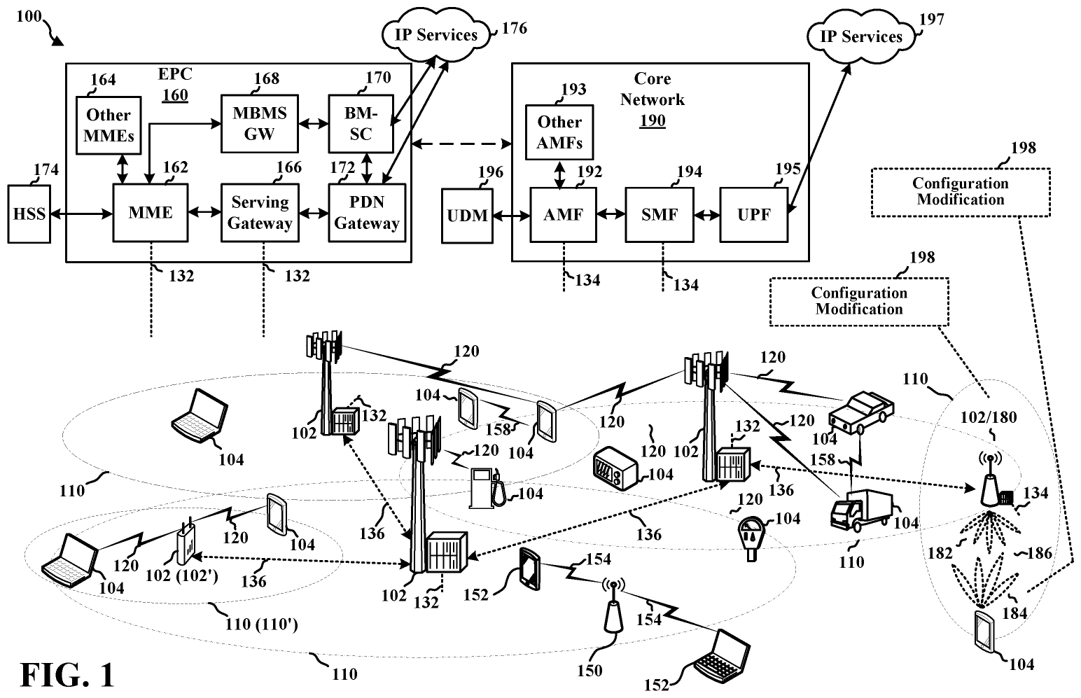

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In certain aspects, the UE 104 may include a configuration modification component 198 that is configured to determine whether a CG or SPS occasion overlaps in at least one SBFD symbol in a partially full-duplex slot based on the CG or SPS configuration, and communicate with a base station according to a modification to the CG or SPS occasion based on the CG or SPS occasion overlapping in at least one SBFD symbol in the partially full-duplex slot.

In certain aspects, the base station 102/180 (or other network device with base station functionality) may include a configuration modification component 199 that is configured to receive a determination of whether a CG or SPS occasion overlaps in at least one SBFD symbol in a partially full-duplex slot based on the CG or SPS configuration, and communicate with a UE according to a modification to the CG or SPS occasion based on the CG or SPS occasion overlapping in at least one SBFD symbol in the partially full-duplex slot.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

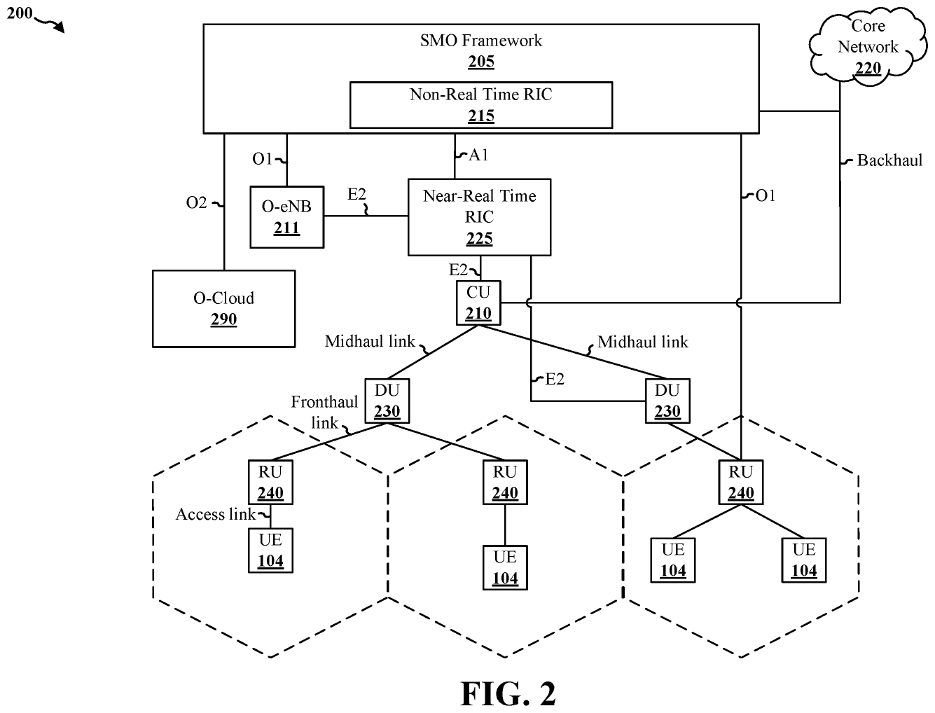

FIG. 2 shows a diagram illustrating an example disaggregated base station 181 architecture. The disaggregated base station 200 architecture may include one or more CUs 210 that can communicate directly with core network 220 via a backhaul link, or indirectly with the core network 220 through one or more disaggregated base station units (such as a Near-Real Time RIC 225 via an E2 link, or a Non-Real Time RIC 225 associated with a Service Management and Orchestration (SMO) Framework 205, or both). A CU 210 may communicate with one or more DUs 230 via respective mid-haul links, such as an F1 interface. The DUs 230 may communicate with one or more RUs 240 via respective fronthaul links. The RUs 240 may communicate respectively with UEs 104 via one or more radio frequency (RF) access links. In some implementations, the UE 104 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include the Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 225 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

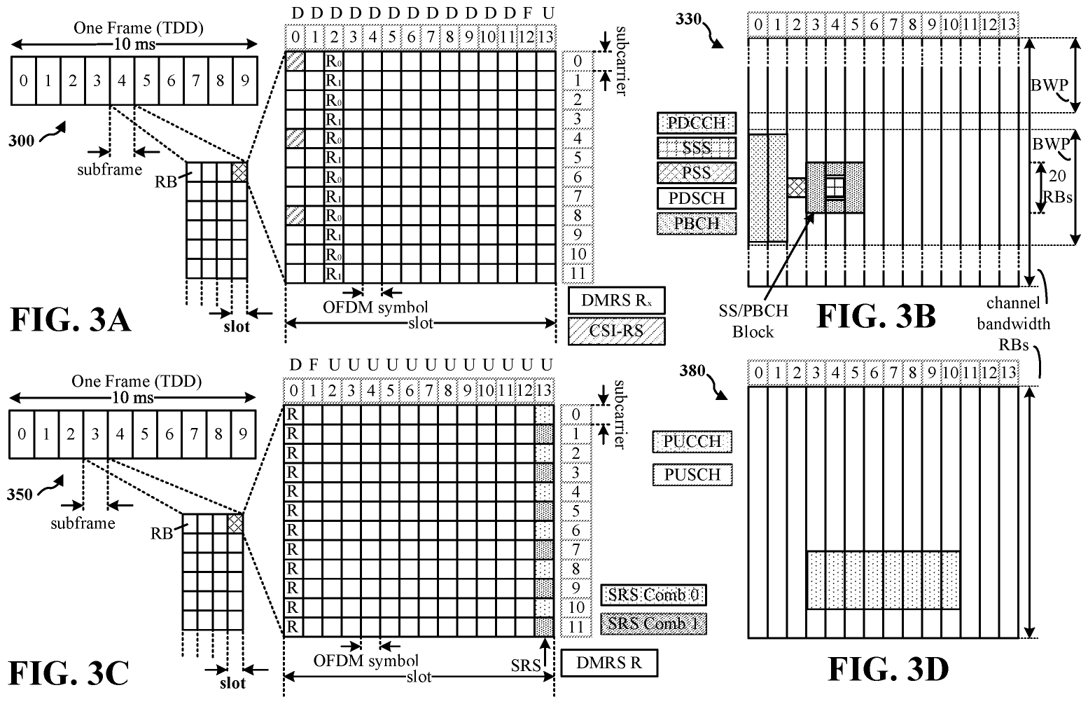

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies id 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and μ2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. Broadly, RSs may be used for beam training and management, tracking and positioning, channel estimation, and/or other such purposes. In some configurations, an RS may include at least one demodulation RS (DM-RS) (indicated as Rₓ for one particular configuration, where 100x is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

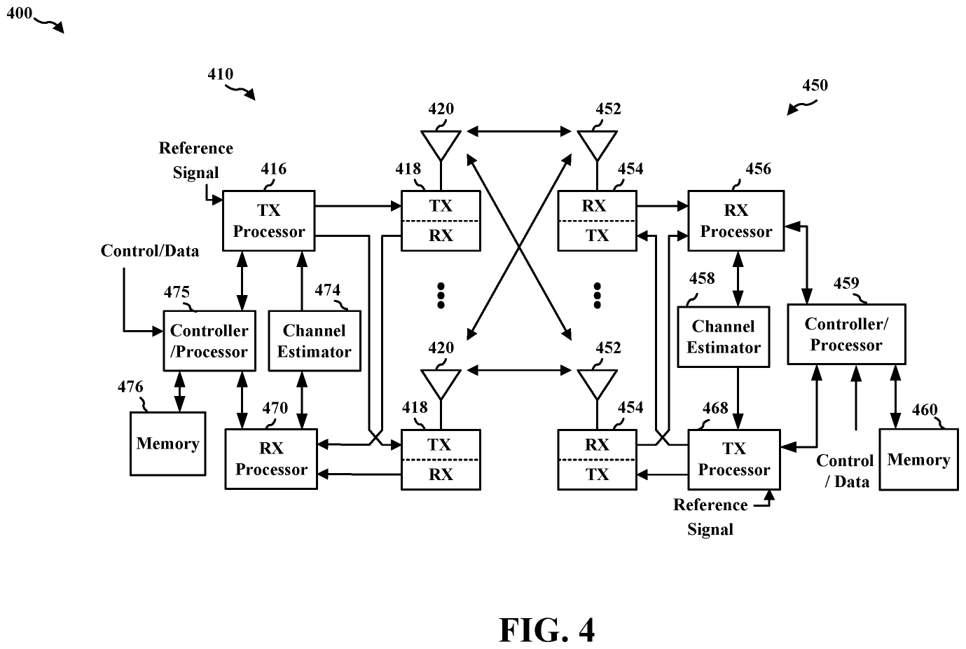

FIG. 4 is a block diagram of a network device 410 such as a base station in communication with a UE 450 in an access network. In the DL, IP packets from the EPC 160 may be provided to a controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 456 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna 420 via a separate transmitter 418TX. Each transmitter 418TX may modulate an RF carrier with a respective spatial stream for transmission.

At the UE 450, each receiver 454RX receives a signal through its respective antenna 452. Each receiver 454RX recovers information modulated onto an RF carrier and provides the information to the receive (RX) processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the network device 410. These soft decisions may be based on channel estimates computed by the channel estimator 458. The soft decisions are then decoded and deinterleaved to recover the data and control signals that were originally transmitted by the network device 410 on the physical channel. The data and control signals are then provided to the controller/processor 459, which implements layer 3 and layer 2 functionality.

The controller/processor 459 can be associated with a memory 460 that stores program codes and data. The memory 460 may be referred to as a computer-readable medium. In the UL, the controller/processor 459 provides demultiplexing between transport and logical channels, packet reassembly, deciphering, header decompression, and control signal processing to recover IP packets from the EPC 160. The controller/processor 459 is also responsible for error detection using an ACK and/or NACK protocol to support HARQ operations.

Similar to the functionality described in connection with the DL transmission by the network device 410, the controller/processor 459 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by the network device 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The UL transmission is processed at the network device 410 in a manner similar to that described in connection with the receiver function at the UE 450. Each receiver 418RX receives a signal through its respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. In the UL, the controller/processor 475 provides demultiplexing between transport and logical channels, packet reassembly, deciphering, header decompression, control signal processing to recover IP packets from the UE 450. IP packets from the controller/processor 475 may be provided to the EPC 160. The controller/processor 475 is also responsible for error detection using an ACK and/or NACK protocol to support HARQ operations.

At least one of the TX processor 468, the RX processor 456, and the controller/processor 459 may be configured to perform aspects in connection with configuration modification component 198 of FIG. 1.

At least one of the TX processor 416, the RX processor 470, and the controller/processor 475 may be configured to perform aspects in connection with configuration modification component 199 of FIG. 1.

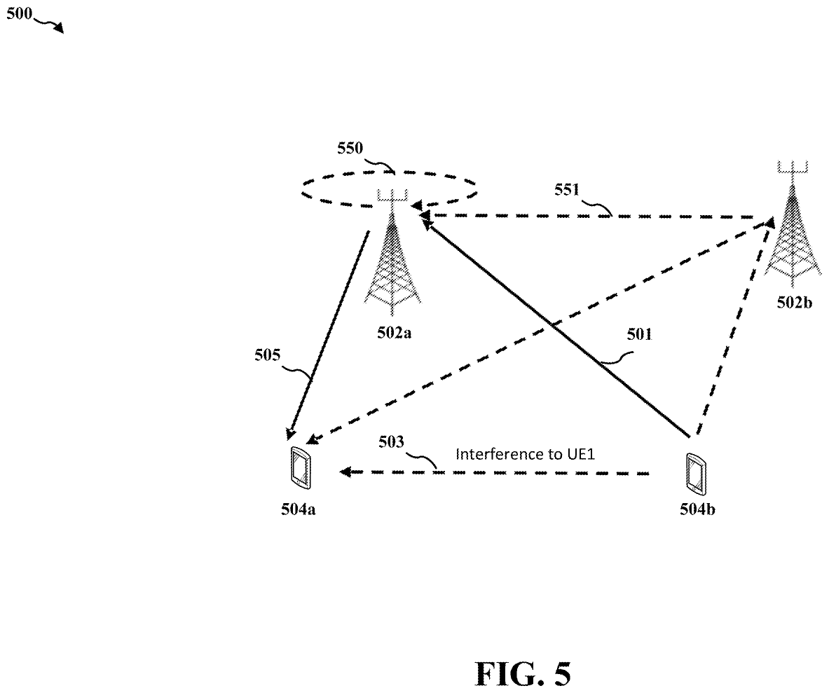

FIG. 5 illustrates an example 500 in which a full duplex wireless communication mode may be implemented by at least one wireless device of particular communication links. It should be appreciated that FIG. 5 represents a portion of a wireless network 100 selected for illustrating full-duplex communications and that the particular base stations and UEs depicted are not intended to be limiting with respect to the various wireless communication stations that may operate in a full-duplex communication mode or that may implement full-duplex slot formats according to concepts of the disclosure.

In the example 500 of FIG. 5, base stations 502a and 502b are each operating in a full-duplex mode while UEs 504a and 504b are each operating in a half-duplex mode. In this example, base stations 502a receives uplink signal 501 and transmits downlink signal 505 using a shared time resource, and possibly a shared frequency resource. Correspondingly, UE 504b transmits uplink signal 501 and UE 504a receives downlink signal 505 sharing a time resource and possibly sharing a frequency resource in addition to external interference (e.g., interference 503 from UE 504b). Base station 502a may experience self-interference 550 associated with transmission of downlink signal 505 when attempting to receive uplink signal 501 in addition to external interference (e.g., interference 551 from base station 502b).

These interferences can decrease quality and/or reliability of communications in the network. Additionally, these interference can also reduce throughput and/or increase latency by causing communication losses and thus additional retransmissions.

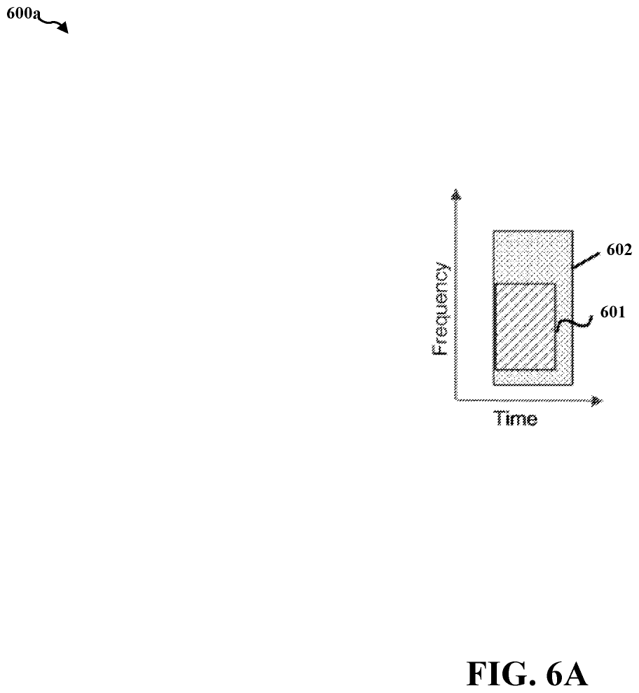

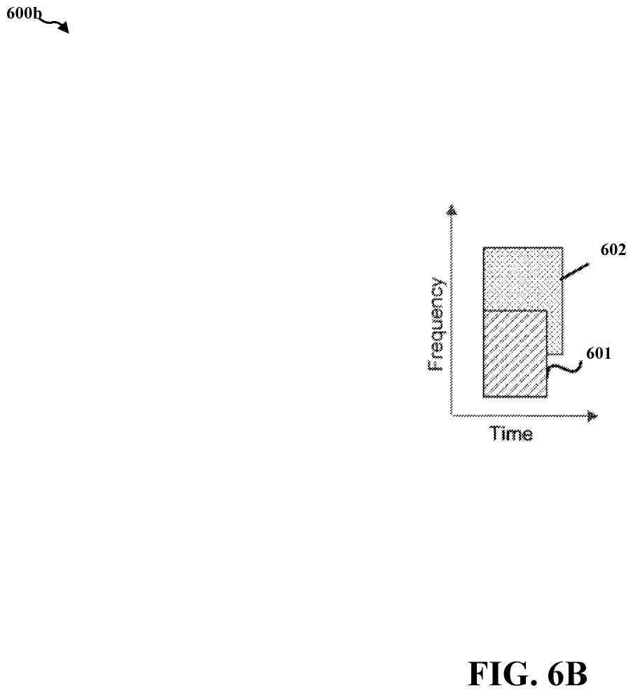

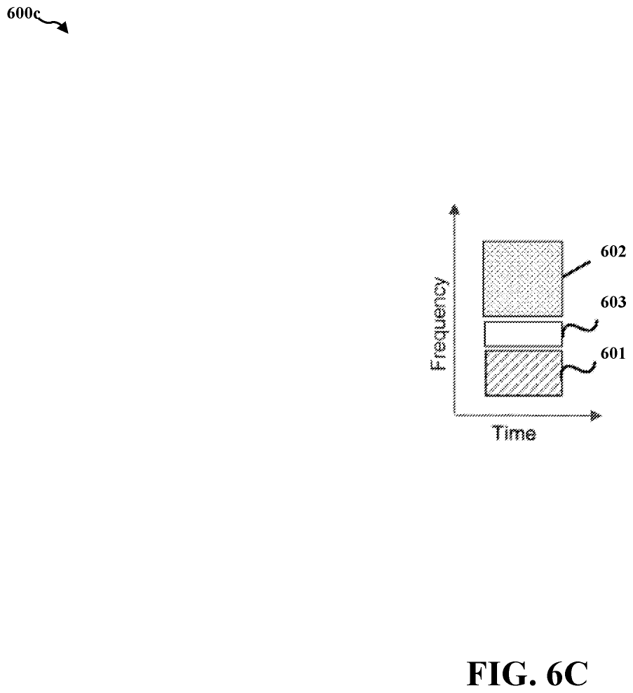

FIGS. 6A-6C illustrate various configurations of full-duplex mode as may be utilized by wireless devices of wireless network 100. It should be appreciated that FIGS. 6A-6C present examples with respect to full-duplex mode configurations that may be utilized and are not intended to be limiting with respect to the particular duplex mode configurations that may be utilized by wireless communication stations that may implement full-duplex slot formats according to concepts of the disclosure.

As can be seen in FIGS. 6A-6C, uplink signals 601 of the full-duplex modes can overlap downlink signals 602 in time. That is, a wireless communication station implementing a full-duplex mode with respect to wireless communications transmits and receives at the same time. In contrast, a wireless communication station implementing a half-duplex mode with respect to wireless communications transmits and receives at different times.

Different configurations may be utilized with respect to a full-duplex mode, as represented by the examples of FIGS. 6A-6C. For example, FIGS. 6A and 6B show examples 600a, 600b of IBFD, wherein uplink signals 601 of the full-duplex modes overlap downlink signals 602 in time and frequency. That is the uplink signals and downlink signals at least partially share the same time and frequency resource (e.g., full or partial overlap of the uplink and downlink signals in the time and frequency domains). This reduces air interference delay due to simultaneously requesting feedback information while transmitting data.

In another example of SBFD, wherein uplink signal 601 of the full-duplex mode overlaps downlink signal 602 in time, but not in frequency. That is the uplink signals and downlink signals at least partially share the same time resources (e.g., full or partial overlap of the uplink and downlink signals in the time domain), but do not share the same frequency resource. This helps with interference cancellation. In the example 600c illustrated in FIG. 6C, uplink signal 601 and downlink signal 602 are separated in the frequency domain by guard band 603 (e.g., a relatively narrow amount of frequency spectrum separating the frequency band occupied by the uplink and downlink signals).

An issue occurs when a CG occasion overlaps with downlink or guard resources of a slot, such as a SBFD slot, due to a slot having mixed half-duplex symbols and SBFD symbol. Similarly, another issue occurs when a SPS occasion overlaps with uplink or guard resources of a slot, such as the SBFD slot, due to the slot having mixed half-duplex symbols and SBFD symbols. In both of these scenarios, it is not clear how a CG occasion or a SPS occasion may behave in those mixed slot types.

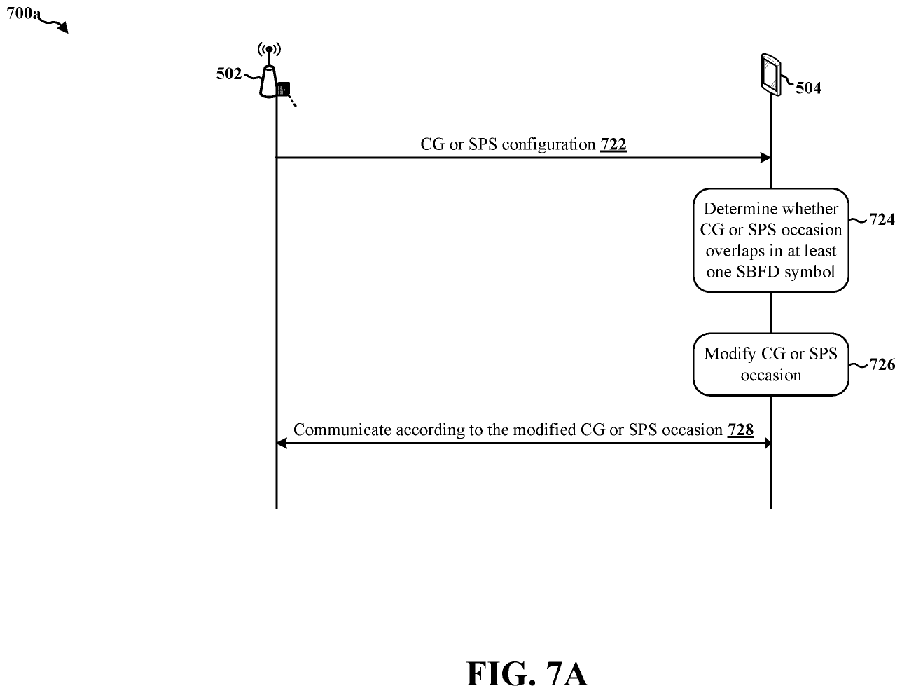

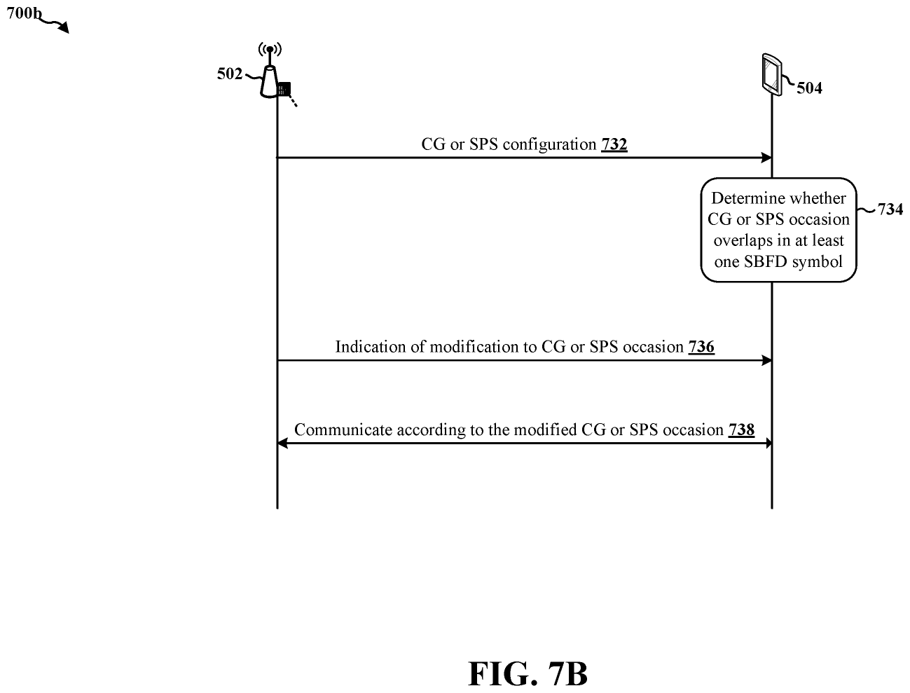

FIG. 7A is a diagram illustrating an example illustrating a call flow between a base station 502 and a UE 504. A process flow 700a illustrates an exemplary sequence of operations performed between the base station 502 and the UE 504 to support communication between the base station 502 and the UE 504 using modified CG or SPS occasions. For example, process flow 700a depicts operations for handling and communicating using modified CG or SPS occasions. It is understood that one or more of the operations described in process flow 700a may be performed earlier or later in the process, omitted, replaced, supplemented, or combined with another operation. Also, additional operations described herein that are not included in process flow 700a may be included in process flow 700a.

At 722, the base station 502 may transmit, and the UE 504 may receive, one or more indications of at least one of a CG or a SPS configuration. In an aspect, the base station 502 may transmit, to the UE 504, at least one CG configuration for transmitting uplink transmission to the base station 502. In an aspects, the base station 502 may transmit, to the UE 504, at least one SPS configuration for receiving downlink transmission from the base station 502.

A CG is where a UE transmits a packet without a scheduling request (SR). CG scheduling for UL eliminates the need to request and assign resources for each packet transmission by pre-allocating resources to the UE. CG are defined by time and frequency resources and similar periodicity.

A SPS is a type of allocation of DL transmissions of PDSCH without having to receive the individual resource allocations for a PDSCH. That is, the UE 504 may be configured to allow periodic DL transmission on a set of resource blocks (E.g., time and frequency resources) with a MCS that is configured via SPS. In some examples, multiple SPS configurations may be indicated to the UE 504. In accordance with techniques described herein, a UE 504 and a base station 502 may be configured with a plurality of slots that include half-duplex and SBFD slots. The base station 502 may transmit, to the UE 504, a SPS configuration for receiving a DL transmission from the base station 502.

Each CG or SPS configuration may be configured for one or more of the plurality of slots. The indication(s) may include one or more radio resource control (RRC) messages (e.g., including a ConfiguredGrantConfig data structure as defined in 3GPP specifications and/or another standard, an SPS-Config data structure as defined in 3GPP specifications and/or another standard, and/or other similar data structures), one or more medium access control (MAC) layer control elements (MAC-CEs), and/or downlink control information (DCI) (e.g., DCI at least partially scrambled using a configured scheduling radio network temporary identifier (CS-RNTI), as defined in 3GPP specifications and/or another standard).

At 724, the UE 504 may determine whether an CG or SPS occasion overlaps in at least one SBFD symbol in a partially full-duplex slot based on the CG of SPS configuration. In an aspect, the UE 504 may determine, for the slot of the plurality of slots, one or more CG occasions for transmission of at least one uplink shared channel transmission based at least in part on the CG configuration. In an aspect, the UE 504 may determine, for the slot of the plurality of slots, one or more SPS occasions for receipt of at least one downlink shared channel transmission based at least in part on the SPS configuration.

In an aspect, the base station 502 may determine whether an CG or SPS occasion overlaps in at least one SBFD symbol in a partially full-duplex slot based on the CG of SPS configuration. In an aspect, the base station 502 may determine, for the slot of the plurality of slots, one or more CG occasions for transmission of at least one uplink shared channel transmission based at least in part on the CG configuration. In an aspect, the base station 502 may determine, for the slot of the plurality of slots, one or more SPS occasions for receipt of at least one downlink shared channel transmission based at least in part on the SPS configuration. The occasions may be determined based on whether the SPS configurations indicate a downlink bandwidth or bandwidth part index, whether the occasions are overlapping with uplink resources, whether the occasions are overlapping with downlink resources, etc., as described herein.

At 726, the UE 504 may determine a modification to the at least one of the CG or the SPS occasion. In an aspect, the modifications may be controlled by a configuration send by the base station 502. In an aspect, the modifications may be implicit. For example, the UE 504 may identify a CG occasion and determine that it is overlapping with 2 DL symbols. Since the UE has identified that the CG occasion is overlapping with 2 DL symbols, the UE will shift the CG occasion by two symbols. The different types of modifications will be explained in further detail with respect to FIGS. 8A-11B.

At 728, the UE 504 may communicate with a base station 502 according to a modification to the CG or SPS occasion based on the CG or SPS occasion overlapping in at least one SBFD symbol in the partially full-duplex slot.

In an aspect, the communication may include receipt by the UE 504 of an uplink shared channel transmission in a CG occasion identified by the CG configuration. For example, the UE 504 may transmit and the base station 502 may receive one or more uplink communications in an uplink slot or an SBFD slot based at least in part on the modification. In an aspects, the uplink shared channel transmission is transmitted in a subset of uplink resources of an CG occasion that overlaps with the downlink or guard resources of the slot or resources of a downlink transmission.

In an aspect, the communication may include transmission of an downlink shared channel transmission in a SPS occasion identified by the SPS occasion. Additionally, or alternatively, the base station 502 may transmit and the UE 504 may receive one or more downlink communications in a downlink slot or an SBFD slot based at least in part on the modification. In some aspects, the downlink shared channel transmission is transmitted in a subset of downlink resources of an SPS occasion that overlaps with the uplink or guard resources of the slot or resources of an uplink transmission.

In this way, a base station 502 and a UE 504 may communicate based on a CG occasion or SPS occasion overlapping in partially full-duplex slot. As a result, modifying the CG or SPS occasion may provide improved performance for uplink transmission, downlink transmission, improved cell coverage, improved spectral efficiency, and/or improved link reliability, among other examples.

FIG. 7B is a diagram illustrating an example illustrating a call flow between a base station 502 and a UE 504. A process flow 700b illustrates an exemplary sequence of operations performed between the base station 502 and the UE 504 to support communication between the base station 502 and the UE 504 using modified CG or SPS occasions. For example, process flow 700b depicts operations for communicating using modified CG or SPS occasions. It is understood that one or more of the operations described in process flow 700b may be performed earlier or later in the process, omitted, replaced, supplemented, or combined with another operation. Also, additional operations described herein that are not included in process flow 700b may be included in process flow 700b.

At 732, the base station 502 may transmit, and the UE 504 may receive, one or more indications of at least one of a CG or a SPS configuration. In an aspect, the base station 502 may transmit, to the UE 504, at least one CG configuration for transmitting uplink transmission to the base station 502. In an aspects, the base station 502 may transmit, to the UE 504, at least one SPS configuration for receiving downlink transmission from the base station 502.

The indication(s) may include one or more radio resource control (RRC) messages (e.g., including a ConfiguredGrantConfig data structure as defined in 3GPP specifications and/or another standard, an SPS-Config data structure as defined in 3GPP specifications and/or another standard, and/or other similar data structures), one or more medium access control (MAC) layer control elements (MAC-CEs), and/or downlink control information (DCI) (e.g., DCI at least partially scrambled using a configured scheduling radio network temporary identifier (CS-RNTI), as defined in 3GPP specifications and/or another standard).

At 734, the UE 504 may determine whether the CG or SPS occasion overlaps in at least one SBFD symbol in a partially full-duplex slot based on the CG of SPS configuration.

At 736, the base station 502 may transmit and the UE 504 may receive an indication of a modification to the at least one of the CG or the SPS occasion. In an aspect, the modifications may be controlled by a configuration send by the base station 502. The different types of modifications will be explained in further detail with respect to FIGS. 8A-11B. Accordingly, the base station 502 may transmit, and the UE 504 may receive, one or more RRC messages, one or more MAC-CEs, and/or DCI that indicate the at least one of a modified CG occasion or a modified SPS occasion. The different types of modifications will be explained in further detail with respect to FIGS. 8A-11B.

At 738, the UE 504 may communicate with a base station 502 according to a modification to the CG or SPS occasion based on the CG or SPS occasion overlapping in at least one SBFD symbol in the partially full-duplex slot. In an aspect, the communication may include receipt by the UE 504 of a downlink shared channel transmission in a CG or SPS occasion identified by the CG or SPS configuration. For example, the UE 504 may transmit and the base station 502 may receive one or more uplink communications in an uplink slot or an SBFD slot based at least in part on the modification. In an aspect, the communication may include transmission of an uplink shared channel transmission in a CG or SPS occasion identified by the CG or SPS occasion. Additionally, or alternatively, the base station 502 may transmit and the UE 504 may receive one or more downlink communications in a downlink slot or an SBFD slot based at least in part on the modification.

By using techniques as described above, the base station 502 may transmit an instruction to the UE 504 to use existing CG and SPS configurations with modifications, such that the base station 502 and the UE 504 conserve network overhead, transmission resources, and decoding resources. Similarly, the UE 504 may transmit an indication to the base station 502 that the UE 504 can continue to use existing CG and SPS configurations with modifications, such that the base station 502 and the UE 504 conserve network overhead, transmission resources, and decoding resources.

As indicated above, FIGS. 7A-7B are provided as examples, Other examples may differ from what is described with respect to FIGS. 7A-7B.

FIG. 8A describes an example 800a of handling a CG occasion 806a that may overlap with a downlink and/or guard resources of an SBFD.

As shown in example 800a, the CG occasion 806a overlaps with half-duplex resource symbols 802 and a SBFD resource symbols 804. In example 800a, each SBFD slot includes a partial slot (e.g., a portion or sub-band of a frequency allocated for use by the base station 502 and the UE 504) for downlink and a partial slot for uplink. In some aspects, partial slots for downlink may be separated from partial slots for uplink by guard bands including one or more frequencies (not shown in the Figures).

Here, the UE 504 is configured to apply a time offset modification by negative N (e.g., transmitting in the slot before) or by positive N (e.g., transmitting in the slot after) in situations where the CG occasion 806a falls in a partially full-duplex slot. In example 800a, the UE 504 applies a time offset of −2 symbols to the CG occasion 806a such that the modified CG occasion 806b overlaps with the half-duplex UL resource symbols 802.

The time offset modification technique is particularly useful when it is expected that every partially full duplex slot will be preceded by a half-duplex slot that is UL. In this case, the UE may reliably subtract 2 symbols and apply the slot offset to be able to transmit the CG.

In an aspect, the modifications may be controlled by a configuration send by the base station 502. For example, base station 502 may transmit a configuration that informs that whenever there is a situation where the CG occasion is overlapping with 2 DL symbols, then the UE will apply a symbol offset by 2.

In an aspect, the modifications may be implicit. For example, the UE 504 may identify the CG occasion and determine that it is overlapping with 2 DL symbols. Since the UE has identified that the CG occasion is overlapping with 2 DL symbols, the UE will shift the CG occasion by two symbols.

FIG. 8B describes an example of handling a CG occasion that may overlap with a downlink and/or guard resources of an SBFD.

As shown in example 800b, the CG occasion 806c overlaps with half-duplex resource symbols 802 and a SBFD resource symbols 804. Here, the UE 504 is configured to apply frequency domain offset modification in terms of symbols in situations where the CG occasion 806c falls in a partially full-duplex slot. In example 800b, the UE 504 applies a frequency domain offset to the CG occasion 806c such that the modified CG occasion 806d overlaps with the half-duplex resource symbols 802 and full-duplex UL resource symbols 804.

In some aspects, the UE 504 may apply both a time offset and frequency domain offset to a CG or SPS occasion. In these situations, the frequency offset may be applied before the time offset. In an aspect, time frequency offset is RRC configured.

FIG. 8C describes an example of handling a SPS occasion that may overlap with a uplink and/or guard resources of an SBFD.

As shown in example 800c, a SPS occasion 806e overlaps with half-duplex resource symbols 802 and a SBFD resource symbols 804. Here, the UE 504 is configured to apply a time offset modification by negative N (e.g., transmitting in the slot before) or by positive N (e.g., transmitting in the slot after) in situations where the SPS occasion 806e falls in a partially full-duplex slot. In example 800c, the UE 504 applies a time offset of −2 symbols to the SPS occasion 806e such that the modified SPS occasion 806f overlaps with the half-duplex DL resource symbols 802.

As indicated above, FIGS. 8A-8C are provided as examples, Other examples may differ from what is described with respect to FIGS. 8A-8C.

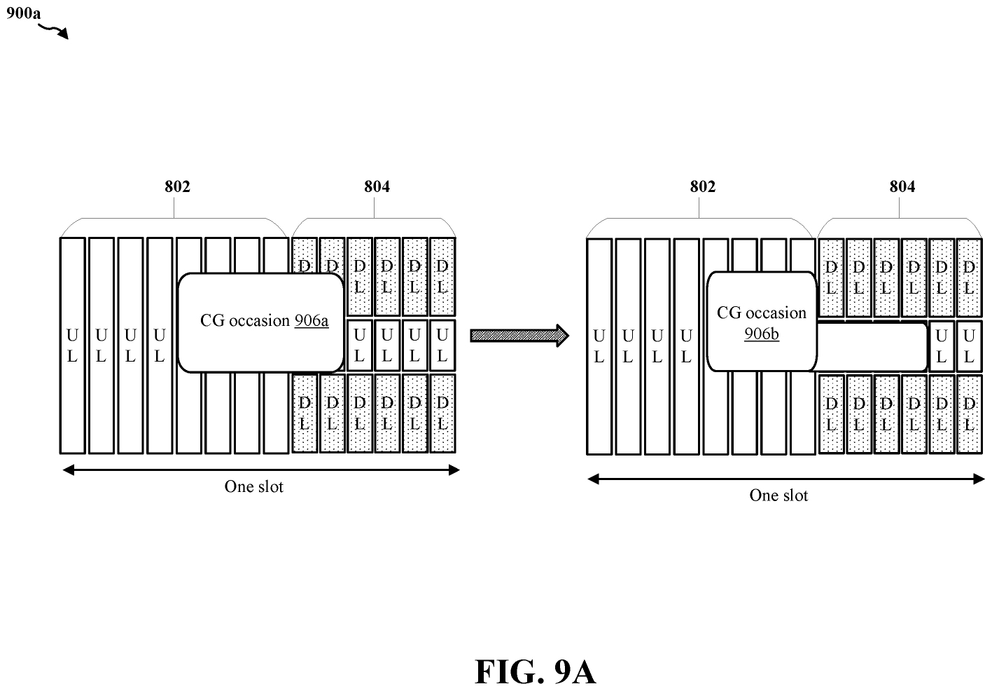

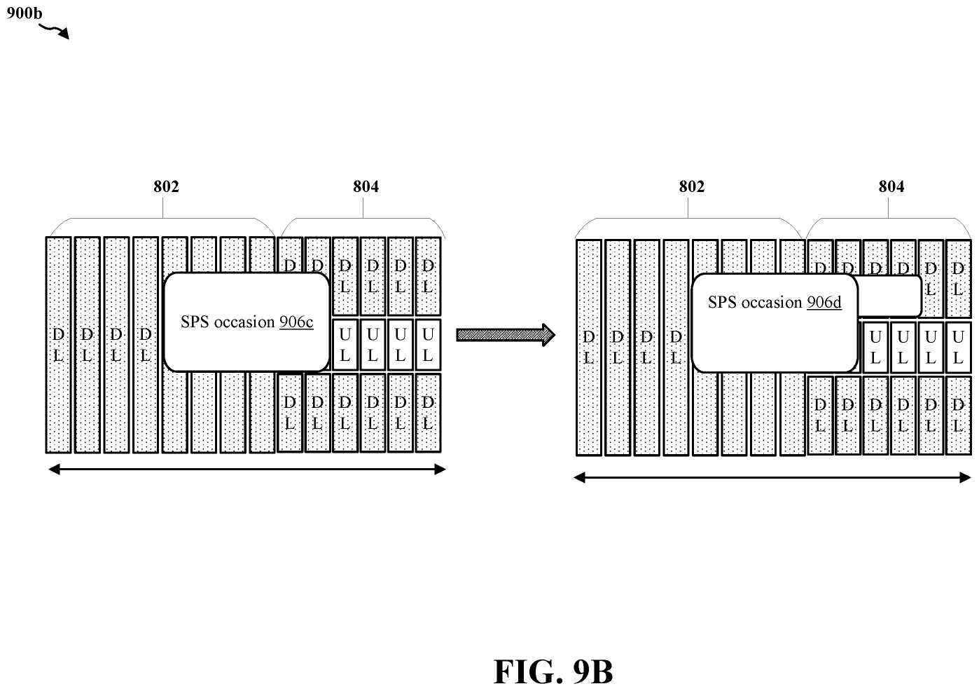

FIG. 9A describes an example of handling a CG occasion that may overlap with a downlink and/or guard resources of an SBFD.

As shown in example 900a, a CG occasion 906a overlaps with half-duplex resource symbols 802 and SBFD resource symbols 804. Here, the UE 504 is configured to apply a spread modification that spreads the occasion in time across available resources given that the same number of resources are available in situations where the occasion falls in a partially full-duplex slot. In example 900a, there are 6 symbols and 4 RBs so there is a total of 24 resources assigned for this CG location. For instance, the UE may “squeeze” the CG grant to fit in the UL resources such that the CG occasion is “stretched” into the SBFD portion and may fit within the same number of resources while still fitting in the UL resources. Here, the UE 504 applies a spread modification to the CG occasion 906a such that the modified CG occasion 906b spreads and overlaps with the half-duplex UL resource symbols 802.

FIG. 9B describes an example of handling a SPS occasion that may overlap with a uplink and/or guard resources of an SBFD.

As shown in example 900b, a SPS occasion 906c overlaps with half-duplex resource symbols 802 and SBFD resource symbols 804. For instance, the UE 504 is configured to apply a spread modification that spreads the occasion in time across available resources given that the same number of resources are available in situations where the occasion falls in a partially full-duplex slot. Here, the UE 504 applies a spread modification to the SPS occasion 906c such that the modified SPS occasion 906d spreads and overlaps with the half-duplex DL resource symbols 804.

As indicated above, FIGS. 9A-9B are provided as examples, Other examples may differ from what is described with respect to FIGS. 9A-9B.

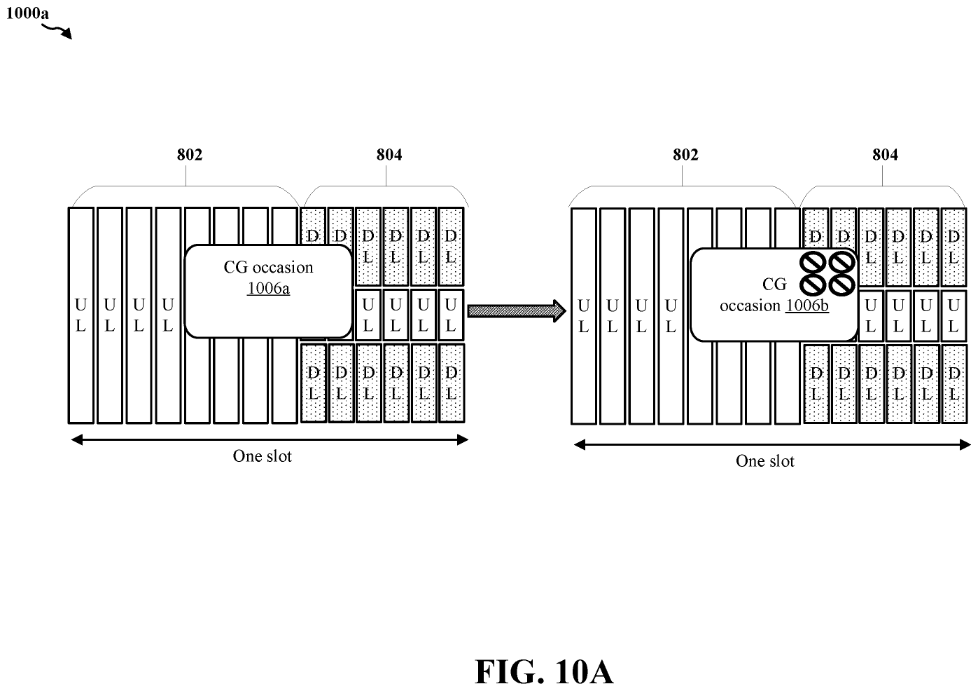

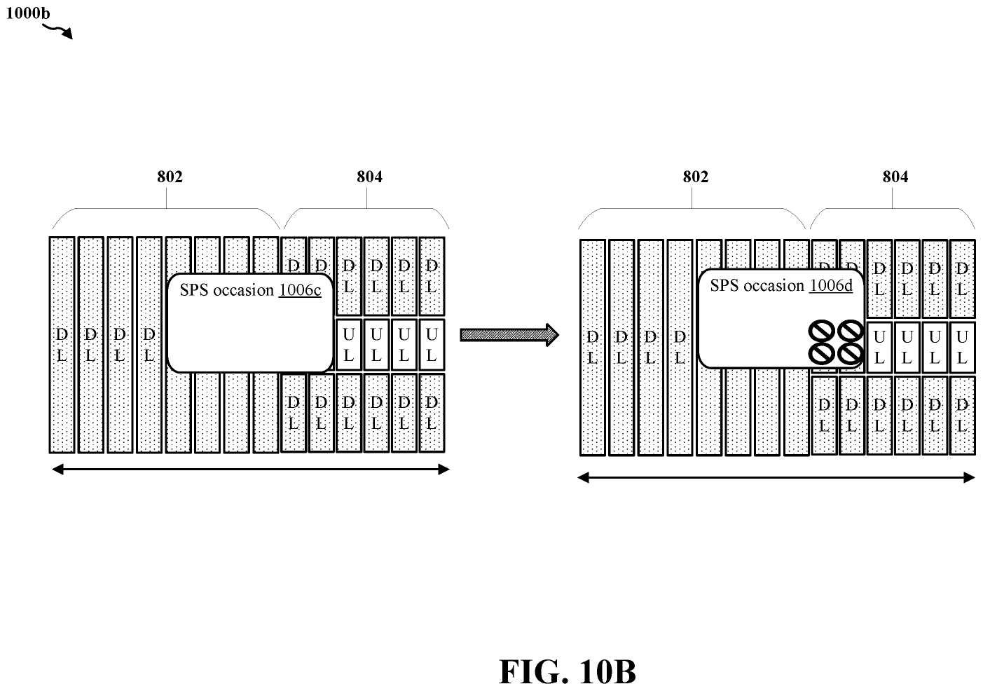

FIG. 10A describes an example of handling a CG occasion that may overlap with a downlink and/or guard resources of an SBFD.

As shown in example 1000a, a CG occasion 1006a overlaps with half-duplex resource symbols 802 and SBFD resource symbols 804. For instance, for CG occasions, the base station 502 is configured to apply puncturing such that coded bits assigned to resource blocks outside the uplink region are not transmitted. Here, the base station 502 applies puncturing to the CG occasion 1006a such that the modified CG occasion 1006b does not transmit resource blocks outside the uplink region.

FIG. 10B describes an example of handling a SPS occasion that may overlap with a uplink and/or guard resources of an SBFD.

As shown in example 1000b, a SPS occasion 1006c overlaps with half-duplex resource symbols 802 and SBFD resource symbols 804. For instance, for SPS occasions, the base station 502 is configured to apply puncturing such that coded bits assigned to resource blocks outside the downlink region are not transmitted. Here, the base station 502 applies puncturing to the SPS occasion 1006c such that the modified SPS occasion 1006d does not transmit resource blocks outside the downlink region.

As indicated above, FIGS. 10A-10B are provided as examples, Other examples may differ from what is described with respect to FIGS. 10A-10B.

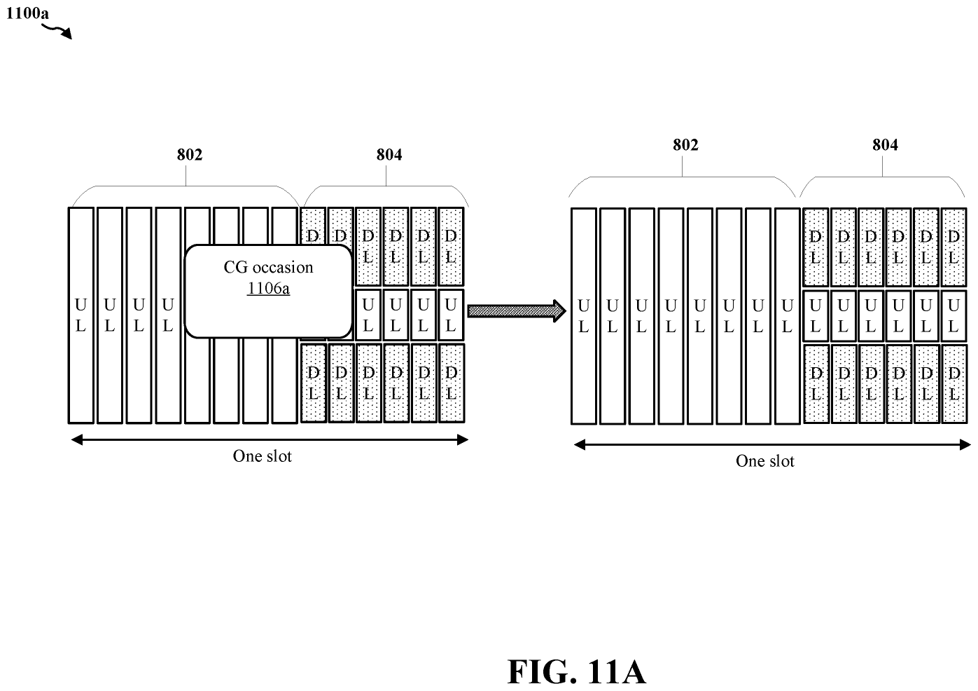

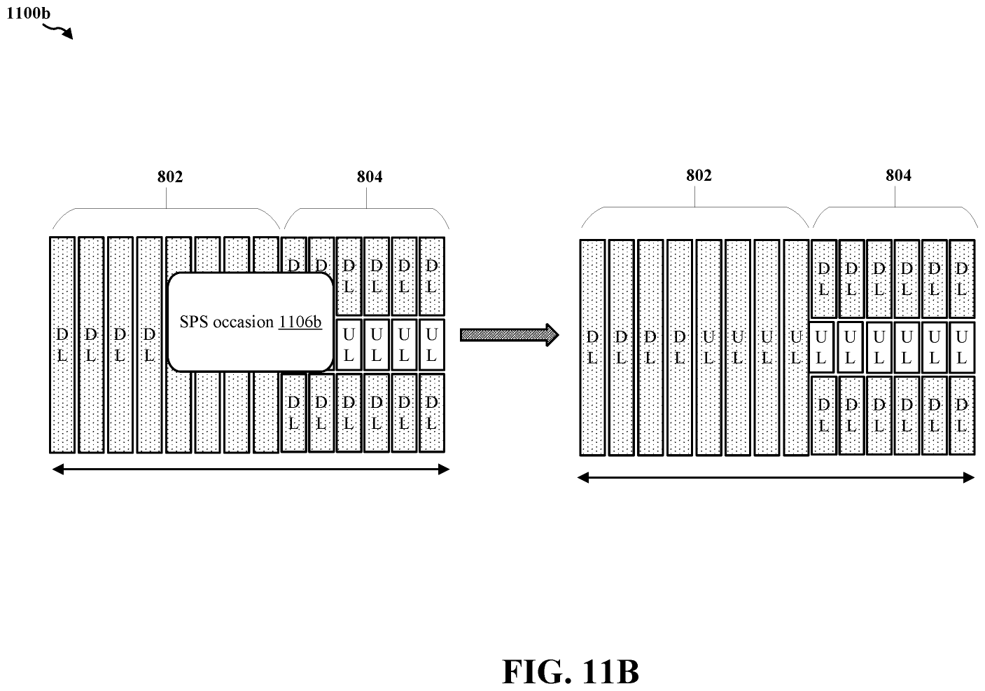

FIG. 11A describes an example of handling a CG occasion that may overlap with a downlink and/or guard resources of an SBFD.

As shown in example 1100a, a CG occasion 1106a overlaps with the half-duplex resource symbols 802 and SBFD resource symbols 804. For instance, the UE 504 may be configured to simply drop an occasion when a CG occasion collides with downlink transmission assuming that the slot is not available for transmission. Here, the UE 504 drops the CG occasion 1106a based on the CG occasion overlapping with the half-duplex resource symbols 802 and full duplex DL resource symbols 804. In some aspects, the UE may also identify an error condition.

FIG. 11B describes an example of handling a SPS occasion that may overlap with a uplink and/or guard resources of an SBFD.

As shown in example 1100b, a SPS occasion 1106b overlaps with the half-duplex resource symbols 802 and SBFD resource symbols 804. For instance, the UE 504 may be configured to drop an occasion when a SPS occasion collides with uplink transmission assuming that the slot is not available for transmission. Here, the UE 504 drops the SPS occasion 1106b based on the SPS occasion overlapping with the half-duplex resource symbols 802 and full duplex UL resource symbols 804. In some aspects, the UE may identify an error condition.

As indicated above, FIGS. 11A-11B are provided as examples, Other examples may differ from what is described with respect to FIGS. 11A-11B.

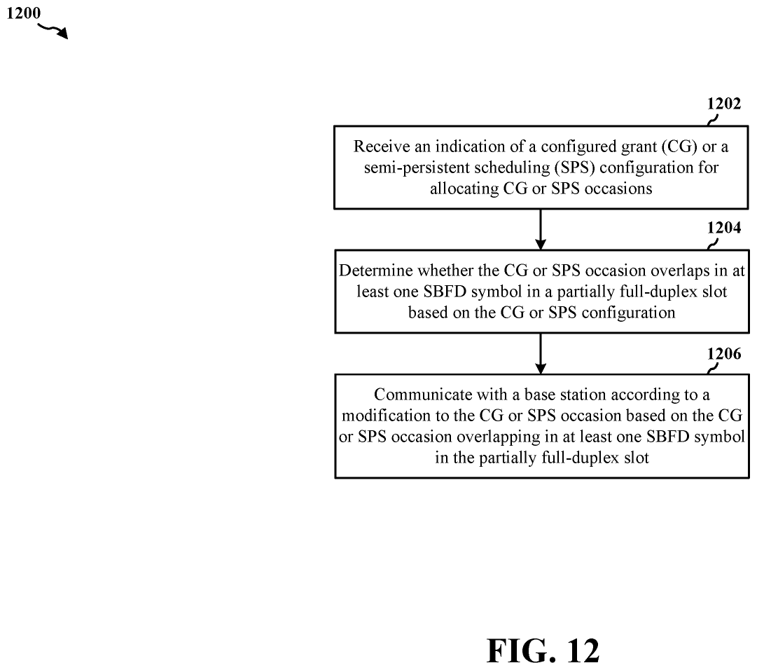

FIG. 12 is a flowchart 1200 of a method of wireless communication. The method may be performed by or at a UE (e.g., the UE 104, 450, 504, 504a, 504b; the apparatus 1502), or one or more components thereof. According to various different aspects, one or more of the illustrated blocks may be omitted, transposed, and/or contemporaneously performed. The method allows a UE to apply modifications to a CG or SPS occasion based on the CG or SPS occasion overlapping with a mix of full-duplex symbols and half duplex symbols.

At 1202, the UE receives an indication of a configured grant (CG) or a semi-persistent scheduling (SPS) configuration for allocating CG or SPS occasions. For example, 1202 may be performed by configuration component 1440. For example, referring to FIG. 7A, at 722, the UE 504 may receive an indication of a CG or SPS configuration for allocating CG or SPS occasions from the base station 502. As another example, referring to FIG. 7B, at 732, the UE 504 may receive an indication of a CG or SPS configuration for allocating CG or SPS occasions from the base station 502.

At 1204, the UE may determine whether the CG or SPS occasion overlaps in at least one SBFD symbol. For example, 1204 may be performed by a slot identification component 1450. For example, referring to FIG. 7A, at 724, the UE 504 may determine whether the CG or SPS occasion overlaps in at least one SBFD symbol. As another example, referring to FIG. 7B, at 734, the UE may determine whether the CG or SPS occasion overlaps in at least one SBFD symbol. As another example, referring back to FIG. 8A, the CG occasion 806a overlaps in at least two SBFD resource symbols 804. As another example, referring back to FIG. 8B, the CG occasion 806c overlaps in at least two SBFD resource symbols 804. As another example, referring back to FIG. 8C, the SPS occasion 806e overlaps in at least two SBFD resource symbols 804. As another example, referring back to FIG. 9A, the CG occasion 906a overlaps in at least two SBFD resource symbols 804. As another example, referring back to FIG. 9B, the SPS occasion 906c overlaps in at least two SBFD resource symbols 804. As another example, referring back to FIG. 10A, the CG occasion 1006a overlaps in at least two SBFD resource symbols 804. As another example, referring back to FIG. 10B, the SPS occasion 1006c overlaps in at least two SBFD resource symbols 804. As another example, referring back to FIG. 10A, the CG occasion 1006a overlaps in at least two SBFD resource symbols 804. As another example, referring back to FIG. 11A, the CG occasion 1106a overlaps in at least two SBFD resource symbols 804. As another example, referring back to FIG. 11B, the SPS occasion 1106b overlaps in at least two SBFD resource symbols 804.

At 1206, the UE may communicate with a base station according to a modification to the CG or SPS occasion based on the CG or SPS occasion overlapping in at least one SBFD symbol in the partially full-duplex slot. For example, 1206 may be performed by an occasion component 1460. For example, referring to FIG. 7A, at 728, the UE 504 may communicate with the base station 502 according to the modified CG or SPS occasion. As another example, referring to FIG. 7B, at 738, the UE 504 communicate with the base station 502 according to the modified CG or SPS occasion.

In an aspect, the modification may be based on applying a time domain offset to the CG or SPS occasion. For example, referring to FIG. 8A, the UE 504 may apply a time offset of −2 symbols to the CG occasion 806a such that the modified CG occasion 806b overlaps with the half-duplex UL resource symbols 802. As another example, referring to FIG. 8C, the UE 504 may apply a time offset of −2 symbols to the SPS occasion 806e such that the modified SPS occasion 806f overlaps with the half-duplex DL resource symbols 802.

In an aspect, the modification may be based on applying a frequency domain offset to the CG or SPS occasion. For example, referring to FIG. 8B, the UE 504 may apply a frequency domain offset to the CG occasion 806c such that the modified CG occasion 806d overlaps with the half-duplex resource symbols 802 and full-duplex UL resource symbols 804.

In an aspect, the modification may be based on spreading the CG or SPS occasion in time across available resources in the partially full-duplex slot based on a same number of resources being available in the partially full-duplex slot. For example, referring to FIG. 9A, the UE 504 may apply a spread modification to the CG occasion 906a such that the modified CG occasion 906b overlaps with the half-duplex UL resource symbols 802. In another example, referring to FIG. 9B, the UE 504 may apply a spread modification to the SPS occasion 906c such that the modified SPS occasion 906d overlaps with the half-duplex DL resource symbols 804.

In an aspect, the modification may be based on puncturing resources from the CG or SPS occasion that overlap in an opposite transmission or reception direction. For example, referring to FIG. 10A, the base station 502 may apply rate puncturing to the CG occasion 1006a such that the modified CG occasion 1006b does not transmit resource blocks outside the uplink region. In another example, referring to FIG. 10B, the base station 502 applies puncturing to the SPS occasion 1006c such that the modified SPS occasion 1006d does not transmit resource blocks outside the downlink region.

In an aspect, information for modifying the CG or SPS occasion may be included in a radio resource control (RRC) communication. In an aspect, the modification may be based on a number of resource blocks (RBs) and symbols for which resources from the CG occasion overlaps with either a guard band or a downlink sub-band. In an aspect, the modification may be based on a number of RBs and symbols for which the SPS occasion overlaps with either a guard band or a uplink sub-band. In an aspect, the modification may be based at least in part on at least one rule stored in the memory.

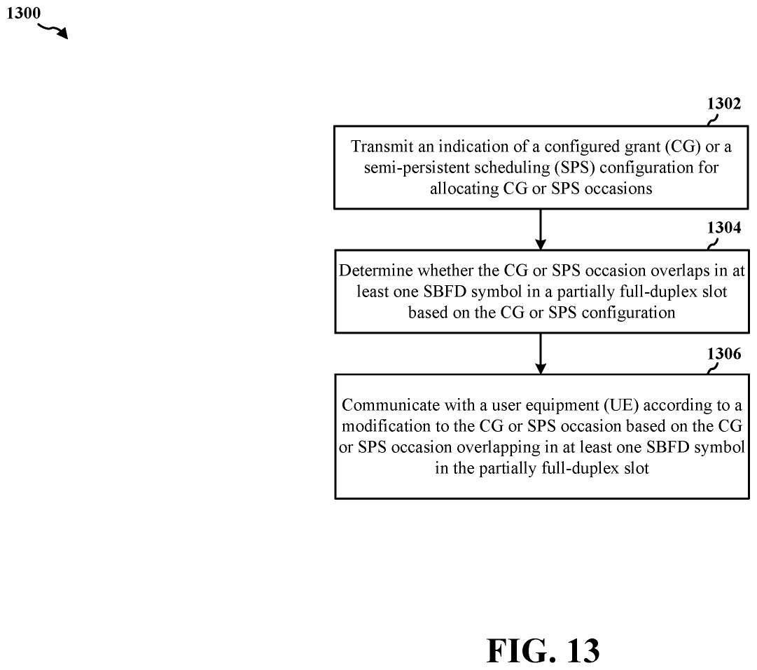

FIG. 13 is a flowchart 1300 of a method of wireless communication. The method may be performed by a base station (e.g., the base station 102/180; disaggregated BS 200; network device 410, 502, 502a, 502b; the apparatus 1502), or one or more components thereof. According to various different aspects, one or more of the illustrated blocks may be omitted, transposed, and/or contemporaneously performed. The method allows a base station to apply modifications to a CG or SPS occasion based on the CG or SPS occasion overlapping with a mix of full-duplex symbols and half duplex symbols.

At 1302, the base station transmits an indication of a configured grant (CG) or a semi-persistent scheduling (SPS) configuration for allocating CG or SPS occasions. For example, 1302 may be performed by configuration component 1540. For example, referring to FIG. 7A, at 722, the base station 502 may transmit an indication of a CG or SPS configuration for allocating CG or SPS occasions to the UE 504. As another example, referring to FIG. 7B, at 732, the base station 502 may transmit an indication of a CG or SPS configuration for allocating CG or SPS occasions to the UE 504.

At 1304, the base station may determine whether the CG or SPS occasion overlaps in at least one SBFD symbol. For example, 1304 may be performed by a slot identification component 1550. For example, referring to FIG. 7A, at 724, the base station 502 may determine whether the CG or SPS occasion overlaps in at least one SBFD symbol. As another example, referring to FIG. 7B, at 734, the base station 502 may determine whether the CG or SPS occasion overlaps in at least one SBFD symbol. As another example, referring back to FIG. 8A, the CG occasion 806a overlaps in at least two SBFD resource symbols 804. As another example, referring back to FIG. 8B, the CG occasion 806c overlaps in at least two SBFD resource symbols 804. As another example, referring back to FIG. 8C, the SPS occasion 806e overlaps in at least two SBFD resource symbols 804. As another example, referring back to FIG. 9A, the CG occasion 906a overlaps in at least two SBFD resource symbols 804. As another example, referring back to FIG. 9B, the SPS occasion 906c overlaps in at least two SBFD resource symbols 804. As another example, referring back to FIG. 10A, the CG occasion 1006a overlaps in at least two SBFD resource symbols 804. As another example, referring back to FIG. 10B, the SPS occasion 1006c overlaps in at least two SBFD resource symbols 804. As another example, referring back to FIG. 10A, the CG occasion 1006a overlaps in at least two SBFD resource symbols 804. As another example, referring back to FIG. 11A, the CG occasion 1106a overlaps in at least two SBFD resource symbols 804. As another example, referring back to FIG. 11B, the SPS occasion 1106b overlaps in at least two SBFD resource symbols 804.

At 1306, the base station may communicate with a user equipment (UE) according to a modification to the CG or SPS occasion based on the CG or SPS occasion overlapping in at least one SBFD symbol in the partially full-duplex slot. For example, 1306 may be performed by an occasion component 1560. For example, referring to FIG. 7A, at 728, the base station 502 may communicate with the UE 504 according to the modified CG or SPS occasion. As another example, referring to FIG. 7B, at 738, the base station 502 communicate with the UE 504 according to the modified CG or SPS occasion.

In an aspect, the modification may be based on applying a time domain offset to the CG or SPS occasion. For example, referring to FIG. 8A, the base station 502 may apply a time offset of −2 symbols to the CG occasion 806a such that the modified CG occasion 806b overlaps with the half-duplex UL resource symbols 802. As another example, referring to FIG. 8C, the base station 502 may apply a time offset of −2 symbols to the SPS occasion 806e such that the modified SPS occasion 806f overlaps with the half-duplex DL resource symbols 802.

In an aspect, the modification may be based on applying a frequency domain offset to the CG or SPS occasion. For example, referring to FIG. 8B, the base station 502 may apply a frequency domain offset to the CG occasion 806c such that the modified CG occasion 806d overlaps with the half-duplex resource symbols 802 and full-duplex UL resource symbols 804.

In an aspect, the modification may be based on spreading the CG or SPS occasion in time across available resources in the partially full-duplex slot based on a same number of resources being available in the partially full-duplex slot. For example, referring to FIG. 9A, the base station 502 may apply a spread modification to the CG occasion 906a such that the modified CG occasion 906b overlaps with the half-duplex UL resource symbols 802. In another example, referring to FIG. 9B, the base station 502 may apply a spread modification to the SPS occasion 906c such that the modified SPS occasion 906d overlaps with the half-duplex DL resource symbols 804.

In an aspect, the modification may be based on puncturing resources from the CG or SPS occasion that overlap in an opposite transmission or reception direction. For example, referring to FIG. 10A, the base station 502 may apply rate puncturing to the CG occasion 1006a such that the modified CG occasion 1006b does not transmit resource blocks outside the uplink region. In another example, referring to FIG. 10B, the base station 502 applies puncturing to the SPS occasion 1006c such that the modified SPS occasion 1006d does not transmit resource blocks outside the downlink region.

In an aspect, information for modifying the CG or SPS occasion may be included in a radio resource control (RRC) communication. In an aspect, the modification may be based on a number of resource blocks (RBs) and symbols for which resources from the CG occasion overlaps with either a guard band or a downlink sub-band. In an aspect, the modification may be based on a number of RBs and symbols for which the SPS occasion overlaps with either a guard band or a uplink sub-band. In an aspect, the modification may be based at least in part on at least one rule stored in the memory.

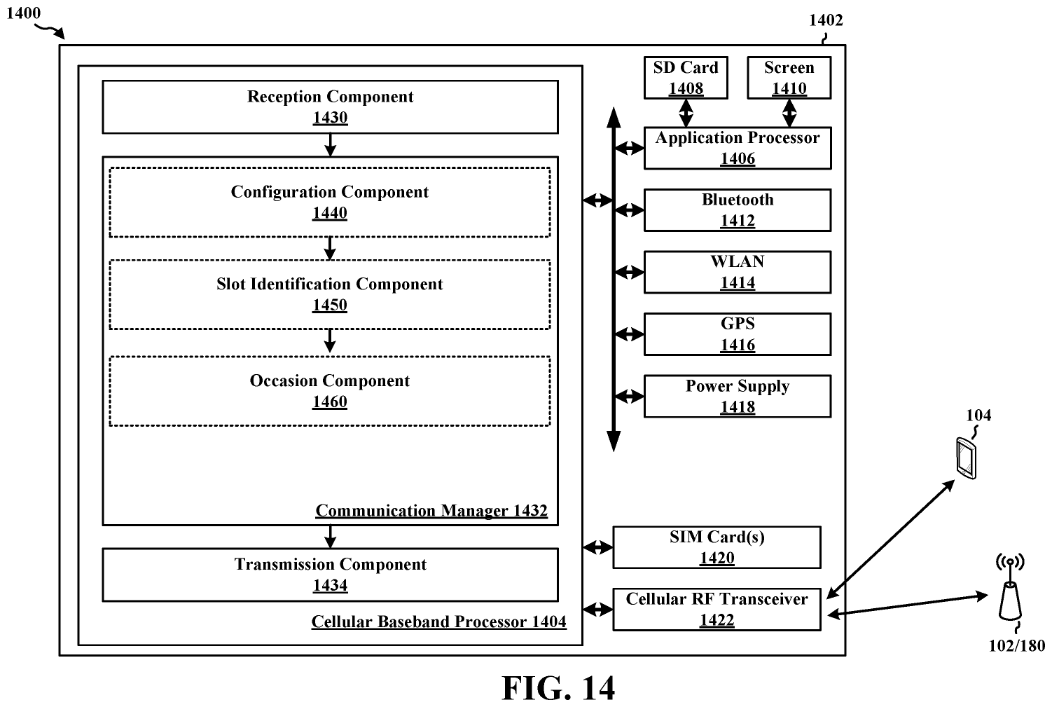

FIG. 14 is a diagram 1400 illustrating an example of a hardware implementation for an apparatus 1402. The apparatus 1402 is a UE and includes a cellular baseband processor 1404 (also referred to as a modem) coupled to a cellular RF transceiver 1422 and one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, and a power supply 1418. The cellular baseband processor 1404 communicates through the cellular RF transceiver 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 450 and may include the memory 460 and/or at least one of the TX processor 468, the RX processor 456, and the controller/processor 459. In one configuration, the apparatus 1402 may be a modem chip and include just the baseband processor 1404, and in another configuration, the apparatus 1402 may be the entire UE (e.g., see 450 of FIG. 4) and include the aforementioned additional modules of the apparatus 1402.

The communication manager 1432 includes a configuration component 1440 that is configured to receive an indication of a configured grant (CG) or a semi-persistent scheduling (SPS) configuration for allocating CG or SPS occasions, e.g., as described in connection with 1202.

The communication manager 1432 further includes a slot identification component 1450 that receives input in the form of the CG or SPS configuration from the configuration component 1440 and is configured to determine whether the CG or SPS occasion overlaps in at least one SBFD symbol in a partially full-duplex slot based on the CG or SPS configuration, e.g., as described in connection with 1204.

The communication manager 1432 further includes an occasion component 1460 that receives input in the form of a determination from the slot identification component 1450 and is configured to communicate with a base station according to a modification to the CG or SPS occasion based on the CG or SPS occasion overlapping in at least one SBFD symbol in the partially full-duplex slot, e.g., as described in connection with 1206.

The apparatus 1402 may include additional components that perform some or all of the blocks, operations, signaling, etc. of the algorithm(s) in the aforementioned call flow diagram(s) and/or flowchart(s) of FIGS. 7A to 11B. As such, each block in the aforementioned flowchart of FIGS. 7A to 11B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1402, and in particular the cellular baseband processor 1404, includes means for receiving an indication of a configured grant (CG) or a semi-persistent scheduling (SPS) configuration for allocating CG or SPS occasions; means for determining whether the CG or SPS occasion overlaps in at least one SBFD symbol in a partially full-duplex slot based on the CG or SPS configuration; and means for communicating with a base station according to a modification to the CG or SPS occasion based on the CG or SPS occasion overlapping in at least one SBFD symbol in the partially full-duplex slot.

In one configuration, the modification is based on applying a time domain offset to the CG or SPS occasion.

In one configuration, the modification is based on applying a frequency domain offset to the CG or SPS occasion.

In one configuration, the modification is based on spreading the CG or SPS occasion in time across available resources in the partially full-duplex slot based on a same number of resources being available in the partially full-duplex slot.

In one configuration, the modification is based on puncturing resources from the CG or SPS occasion that overlap in an opposite transmission or reception direction.

In one configuration, the modification is based on dropping resources from the CG or SPS occasion based on the partially full-duplex slot not being available for transmission.

7. The apparatus of claim 1, wherein information for modifying the CG or SPS occasion is included in a radio resource control (RRC) communication.

In one configuration, the modification is based on a number of resource blocks (RBs) and symbols for which resources from the CG occasion overlaps with either a guard band or a downlink sub-band.

In one configuration, the modification is based on a number of RBs and symbols for which the SPS occasion overlaps with either a guard band or a uplink sub-band.

In one configuration, the modification is based at least in part on at least one rule stored in the memory.

The aforementioned means may be one or more of the aforementioned components of the apparatus 1402 configured to perform the functions recited by the aforementioned means. As described supra, the apparatus 1402 may include the TX Processor 468, the RX Processor 456, and the controller/processor 459. As such, in one configuration, the aforementioned means may be the TX Processor 468, the RX Processor 456, and the controller/processor 459 configured to perform the functions recited by the aforementioned means.

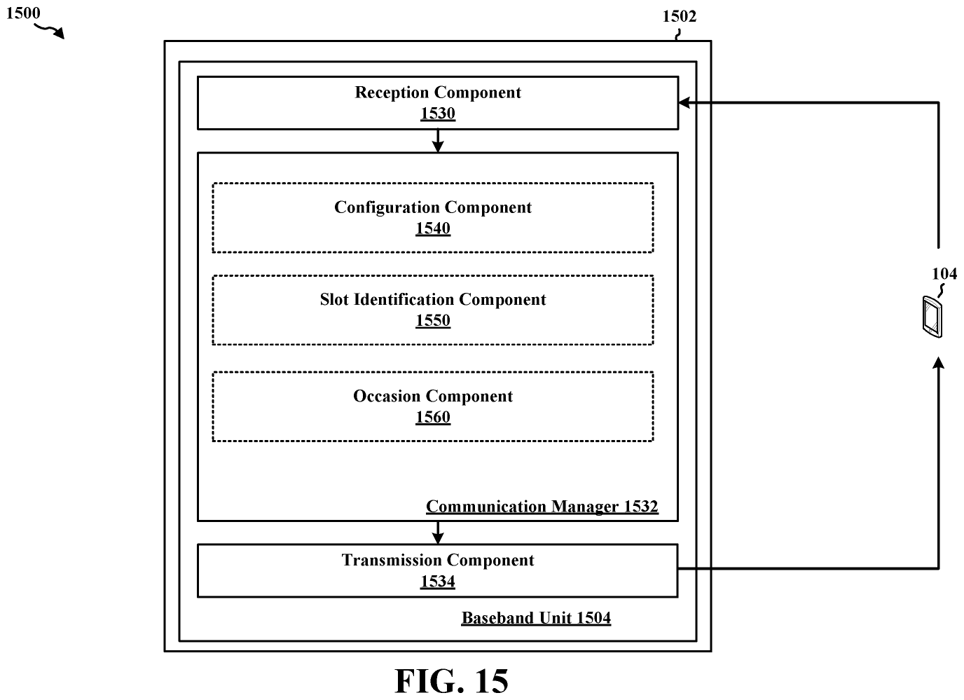

FIG. 15 is a diagram 1500 illustrating an example of a hardware implementation for an apparatus 1502. The apparatus 1502 is a network entity or network device such as a BS and includes a baseband unit 1504. The baseband unit 1504 may communicate through a cellular RF transceiver with the UE 104. The baseband unit 1504 may include a computer-readable medium/memory. The baseband unit 1504 is responsible for general processing, including the execution of software stored on the computer-readable medium/memory. The software, when executed by the baseband unit 1504, causes the baseband unit 1504 to perform the various functions described supra. The computer-readable medium/memory may also be used for storing data that is manipulated by the baseband unit 1504 when executing software. The baseband unit 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the baseband unit 1504. The baseband unit 1504 may be a component of the network device 410 and may include the memory 476 and/or at least one of the TX processor 416, the RX processor 470, and the controller/processor 475.

The communication manager 1532 includes a configuration component 1540 that is configured to transmit an indication of a configured grant (CG) or a semi-persistent scheduling (SPS) configuration for allocating CG or SPS occasions, e.g., as described in connection with 1302.

The communication manager 1532 further includes a slot identification component 1550 that receives input in the form of the CG or SPS configuration from the configuration component 1540 and is configured to determine whether the CG or SPS occasion overlaps in at least one SBFD symbol in a partially full-duplex slot based on the CG or SPS configuration, e.g., as described in connection with 1304.

The communication manager 1532 further includes an occasion component 1560 that receives input in the form of the determination result from the slot identification component 1550 and is configured to communicate with a user equipment (UE) according to a modification to the CG or SPS occasion based on the CG or SPS occasion overlapping in at least one SBFD symbol in the partially full-duplex, e.g., as described in connection with 1306.

The apparatus 1502 may include additional components that perform some or all of the blocks, operations, signaling, etc. of the algorithm(s) in the aforementioned call flow diagram(s) and/or flowchart(s) of FIGS. 7A to 11B. As such, each block in the aforementioned flowchart of FIGS. 7A to 11B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1502, and in particular the baseband unit 1504, includes means for transmitting an indication of a configured grant (CG) or a semi-persistent scheduling (SPS) configuration for allocating CG or SPS occasions; means for determining whether the CG or SPS occasion overlaps in at least one SBFD symbol in a partially full-duplex slot based on the CG or SPS configuration; and means for communicating with a user equipment (UE) according to a modification to the CG or SPS occasion based on the CG or SPS occasion overlapping in at least one SBFD symbol in the partially full-duplex slot.

In one configuration, the modification is based on applying a time domain offset to the CG or SPS occasion.

In one configuration, the modification is based on applying a frequency domain offset to the CG or SPS occasion.

In one configuration, the modification is based on spreading the CG or SPS occasion in time across available resources in the partially full-duplex slot based on a same number of resources being available in the partially full-duplex slot.

In one configuration, the modification is based on puncturing resources from the CG or SPS occasion that overlap in an opposite transmission or reception direction.

In one configuration, the modification is based on dropping resources from the CG or SPS occasion based on the partially full-duplex slot not being available for transmission.

In one configuration, the modification is based on a number of resource blocks (RBs) and symbols for which resources from the CG occasion overlaps with either a guard band or a downlink sub-band.

In one configuration, the modification is based on a number of RBs and symbols for which the SPS occasion overlaps with either a guard band or a uplink sub-band.

In one configuration, the modification is based at least in part on at least one rule stored in the memory.

The aforementioned means may be one or more of the aforementioned components of the apparatus 1502 configured to perform the functions recited by the aforementioned means. As described supra, the apparatus 1502 may include the TX Processor 416, the RX Processor 470, and the controller/processor 475. As such, in one configuration, the aforementioned means may be the TX Processor 416, the RX Processor 470, and the controller/processor 475 configured to perform the functions recited by the aforementioned means.

Accordingly, aspects of the present disclosure allow for a modification of CG or SPS occasions that fall in partially full-duplex slots. For example, the UE may receive an indication of a configured grant (CG) or a semi-persistent scheduling (SPS) configuration for allocating CG or SPS occasions. Next, the UE may determine whether the CG or SPS occasion overlaps in at least one SBFD symbol in a partially full-duplex slot based on the CG or SPS configuration. The UE may communicate with a base station according to a modification to the CG or SPS occasion based on the CG or SPS occasion overlapping in at least one SBFD symbol in the partially full-duplex slot. In this way, the UE and the base station may handle instances where a CG or SPS occasion falls in a partially full-duplex slot without identifying an error conditions or simply dropping the CG or SPS occasion.

Particular aspects of the subject matter described herein may be implemented to realize one or more advantages. The described techniques may support improvements in the CG, SPS, and SBFD framework, decreasing signaling overhead, and improving reliability, among other advantages. As such, supported techniques may include improved network operations and, in some examples, may promote network efficiencies, among other benefits.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Aspect 1 is an apparatus for wireless communication, comprising:
a. a memory; and
b. at least one processor coupled to the memory and configured to:
c. receive an indication of a configured grant (CG) or a semi-persistent scheduling (SPS) configuration for allocating CG or SPS occasions;
d. determine whether the CG or SPS occasion overlaps in at least one SBFD symbol in a partially full-duplex slot based on the CG or SPS configuration; and
e. communicate with a base station according to a modification to the CG or SPS occasion based on the CG or SPS occasion overlapping in at least one SBFD symbol in the partially full-duplex slot.

Aspect 2 is the apparatus of Aspect 1, wherein the modification is based on applying a time domain offset to the CG or SPS occasion.

Aspect 3 is the apparatus of Aspects 1 or 2, wherein the modification is based on applying a frequency domain offset to the CG or SPS occasion.

Aspect 4 is the apparatus of any of Aspects 1 to 3, wherein the modification is based on spreading the CG or SPS occasion in time across available resources in the partially full-duplex slot based on a same number of resources being available in the partially full-duplex slot.

Aspect 5 is the apparatus of any of the Aspects 1 to 4, wherein the modification is based on puncturing resources from the CG or SPS occasion that overlap in an opposite transmission or reception direction.

Aspect 6 is the apparatus of any of the Aspects 1 to 4, wherein the modification is based on dropping resources from the CG or SPS occasion based on the partially full-duplex slot not being available for transmission.

Aspect 7 is the apparatus of any of the Aspects 1 to 6, wherein information for modifying the CG or SPS occasion is included in a radio resource control (RRC) communication.

Aspect 8 is the apparatus of any of Aspects 1 to 7, wherein the modification is based on a number of resource blocks (RBs) and symbols for which resources from the CG occasion overlaps with either a guard band or a downlink sub-band.

Aspect 9 is the apparatus of any of Aspects 1 to 10, wherein the modification is based on a number of RBs and symbols for which the SPS occasion overlaps with either a guard band or a uplink sub-band.

Aspect 10 is the apparatus of any of Aspects 1 to 9, wherein the modification is based at least in part on at least one rule stored in the memory.

Aspect 11 is an apparatus for wireless communication at a base station, comprising:
a. a memory; and
b. at least one processor coupled to the memory and configured to:
c. transmit an indication of a configured grant (CG) or a semi-persistent scheduling (SPS) configuration for allocating CG or SPS occasions;
d. determine whether the CG or SPS occasion overlaps in at least one SBFD symbol in a partially full-duplex slot based on the CG or SPS configuration; and
i. communicate with a user equipment (UE) according to a modification to the CG or SPS occasion based on the CG or SPS occasion overlapping in at least one SBFD symbol in the partially full-duplex slot.

Aspect 12 is the apparatus of Aspect 11, wherein the modification comprises applying a time domain offset to the CG or SPS occasion.

Aspect 13 is the apparatus of Aspect 11 or 12, wherein the modification comprises applying a frequency domain offset to the CG or SPS occasion.

Aspect 14 is the apparatus of any of the Aspects 11 to 13, wherein the modification comprises puncturing resources from the CG or SPS occasion that overlap in an opposite transmission or reception direction.

Aspect 15 is the apparatus of any of the Aspects 11 to 14, wherein the modification comprise dropping resources from the CG or SPS occasion based on the partially full-duplex slot not being available for transmission.

Aspect 16 is the apparatus of any of the Aspects 11 to 15, wherein information for modifying the CG or SPS occasion is included in a radio resource control (RRC) communication.

Aspect 17 is the apparatus of any of the Aspects 11 to 16, wherein the modification is based on a number of resource blocks (RBs) and symbols for which resources from the CG occasion overlaps with either a guard band or a downlink sub-band.

Aspect 18 is the apparatus of any of the Aspects 11 to 17, wherein the modification is based on a number of RBs and symbols for which the SPS occasion overlaps with either a guard band or a uplink sub-band.

Aspect 19 is the apparatus of any of the Aspects 11 to 18, wherein the modification is based at least in part on at least one rule stored in the memory.

Aspect 20 is a method of wireless communication at a user equipment (UE), comprising:
a. receiving an indication of a configured grant (CG) or a semi-persistent scheduling (SPS) configuration for allocating CG or SPS occasions;
b. determining whether the CG or SPS occasion overlaps in at least one SBFD symbol in a partially full-duplex slot based on the CG or SPS configuration; and
c. communicating with a base station according to a modification to the CG or SPS occasion based on the CG or SPS occasion overlapping in at least one SBFD symbol in the partially full-duplex slot.

Aspect 21 is the method of Aspect 20, wherein the modification comprises applying a time domain offset to the CG or SPS occasion.

Aspect 22 is the method of Aspect 20 or 21, wherein the modification comprises applying a frequency domain offset to the CG or SPS occasion.

Aspect 23 is the method of any of the Aspects 20 to 22, wherein the modification comprises spreading the CG or SPS occasion in time across available resources in the partially full-duplex slot based on a same number of resources being available in the partially full-duplex slot.

Aspect 24 is the method of any of the Aspects 20 to 23, wherein the modification comprises puncturing resources from the CG or SPS occasion that overlap in an opposite transmission or reception direction.

Aspect 25 is the method of any of the Aspects 20 to 24, wherein the modification comprise dropping resources from the CG or SPS occasion based on the partially full-duplex slot not being available for transmission.

Aspect 26 is a method of wireless communication at a network entity, comprising:
a. transmitting an indication of a configured grant (CG) or a semi-persistent scheduling (SPS) configuration for allocating CG or SPS occasions;
b. determining whether the CG or SPS occasion overlaps in at least one SBFD symbol in a partially full-duplex slot based on the CG or SPS configuration; and
c. communicating with a user equipment (UE) according to a modification to the CG or SPS occasion based on the CG or SPS occasion overlapping in at least one SBFD symbol in the partially full-duplex slot.

Aspect 27 is the method of Aspect 26, wherein the modification comprises applying a time domain offset or a frequency domain offset to the CG or SPS occasion.

Aspect 28 is the method of Aspect 26 or 27, wherein the modification comprises applying a frequency domain offset to the CG or SPS occasion.

Aspect 29 is the method of any of the Aspects 26 to 28, wherein the modification comprises spreading the CG or SPS occasion in time across available resources in the partially full-duplex slot based on a same number of resources being available in the partially full-duplex slot.

Aspect 30 is the method of the method of any of the Aspects 26 to 29, wherein the modification comprises puncturing resources from the CG or SPS occasion that overlap in an opposite transmission or reception direction.

What is claimed is:

1. An apparatus for wireless communication at a user equipment (UE), comprising:
a memory; and
at least one processor coupled to the memory and configured to:
receive an indication of a configured grant (CG) or a semi-persistent scheduling (SPS) configuration for allocating CG or SPS occasions;
determine whether the CG or SPS occasion overlaps in at least one SBFD symbol in a partially full-duplex slot based on the CG or SPS configuration; and
communicate with a base station according to a modification to the CG or SPS occasion based on the CG or SPS occasion overlapping in at least one SBFD symbol in the partially full-duplex slot.

2. The apparatus of claim 1, wherein the modification is based on applying a time domain offset to the CG or SPS occasion.

3. The apparatus of claim 1, wherein the modification is based on applying a frequency domain offset to the CG or SPS occasion.

4. The apparatus of claim 1, wherein the modification is based on spreading the CG or SPS occasion in time across available resources in the partially full-duplex slot based on a same number of resources being available in the partially full-duplex slot.

5. The apparatus of claim 1, wherein the modification is based on puncturing resources from the CG or SPS occasion that overlap in an opposite transmission or reception direction.

6. The apparatus of claim 1, wherein the modification is based on dropping resources from the CG or SPS occasion based on the partially full-duplex slot not being available for transmission.

7. The apparatus of claim 1, wherein information for modifying the CG or SPS occasion is included in a radio resource control (RRC) communication.

8. The apparatus of claim 1, wherein the modification is based on a number of resource blocks (RBs) and symbols for which resources from the CG occasion overlaps with either a guard band or a downlink sub-band.

9. The apparatus of claim 1, wherein the modification is based on a number of RBs and symbols for which the SPS occasion overlaps with either a guard band or a uplink sub-band.

10. The apparatus of claim 1, wherein the modification is based at least in part on at least one rule stored in the memory.

11. An apparatus for wireless communication at a base station, comprising:
a memory; and
at least one processor coupled to the memory and configured to:
transmit an indication of a configured grant (CG) or a semi-persistent scheduling (SPS) configuration for allocating CG or SPS occasions;
determine whether the CG or SPS occasion overlaps in at least one SBFD symbol in a partially full-duplex slot based on the CG or SPS configuration; and
communicate with a user equipment (UE) according to a modification to the CG or SPS occasion based on the CG or SPS occasion overlapping in at least one SBFD symbol in the partially full-duplex slot.

12. The apparatus of claim 11, wherein the modification comprises applying a time domain offset to the CG or SPS occasion.

13. The apparatus of claim 11, wherein the modification comprises applying a frequency domain offset to the CG or SPS occasion.

14. The apparatus of claim 11, wherein the modification comprises puncturing resources from the CG or SPS occasion that overlap in an opposite transmission or reception direction.

15. The apparatus of claim 11, wherein the modification comprise dropping resources from the CG or SPS occasion based on the partially full-duplex slot not being available for transmission.

16. The apparatus of claim 11, wherein information for modifying the CG or SPS occasion is included in a radio resource control (RRC) communication.

17. The apparatus of claim 11, wherein the modification is based on a number of resource blocks (RBs) and symbols for which resources from the CG occasion overlaps with either a guard band or a downlink sub-band.

18. The apparatus of claim 11, wherein the modification is based on a number of RBs and symbols for which the SPS occasion overlaps with either a guard band or a uplink sub-band.

19. The apparatus of claim 11, wherein the modification is based at least in part on at least one rule stored in the memory.

20. A method of wireless communication performed by a user equipment (UE), comprising:
receiving an indication of a configured grant (CG) or a semi-persistent scheduling (SPS) configuration for allocating CG or SPS occasions;
determining whether the CG or SPS occasion overlaps in at least one SBFD symbol in a partially full-duplex slot based on the CG or SPS configuration; and
communicating with a base station according to a modification to the CG or SPS occasion based on the CG or SPS occasion overlapping in at least one SBFD symbol in the partially full-duplex slot.

21. The method of claim 20, wherein the modification comprises applying a time domain offset to the CG or SPS occasion.

22. The method of claim 20, wherein the modification comprises applying a frequency domain offset to the CG or SPS occasion.

23. The method of claim 20, wherein the modification comprises spreading the CG or SPS occasion in time across available resources in the partially full-duplex slot based on a same number of resources being available in the partially full-duplex slot.

24. The method of claim 20, wherein the modification comprises puncturing resources from the CG or SPS occasion that overlap in an opposite transmission or reception direction.

25. The method of claim 20, wherein the modification comprise dropping resources from the CG or SPS occasion based on the partially full-duplex slot not being available for transmission.

26. A method of wireless communication performed by a base station, comprising:
transmitting an indication of a configured grant (CG) or a semi-persistent scheduling (SPS) configuration for allocating CG or SPS occasions;
determining whether the CG or SPS occasion overlaps in at least one SBFD symbol in a partially full-duplex slot based on the CG or SPS configuration; and
communicating with a user equipment (UE) according to a modification to the CG or SPS occasion based on the CG or SPS occasion overlapping in at least one SBFD symbol in the partially full-duplex slot.

27. The method of claim 26, wherein the modification comprises applying a time domain offset or a frequency domain offset to the CG or SPS occasion.

28. The method of claim 26, wherein the modification comprises applying a frequency domain offset to the CG or SPS occasion.

29. The method of claim 26, wherein the modification comprises spreading the CG or SPS occasion in time across available resources in the partially full-duplex slot based on a same number of resources being available in the partially full-duplex slot.

30. The method of claim 26, wherein the modification comprises puncturing resources from the CG or SPS occasion that overlap in an opposite transmission or reception direction.
